(19) United States
(12) Patent Application Publication
(10) Pub. No.: US 2020/0316507 A1
(43) Pub. Date: Oct. 8, 2020

(54) ELECTRIC COMPRESSOR HAVING IMPROVED OIL SEPARATION EFFICIENCY

(71) Applicant: LG ELECTRONICS INC., Seoul (KR)

(72) Inventors: Kitae JANG, Seoul (KR); Honghee PARK, Seoul (KR); Sanghun SEONG, Seoul (KR); Jaesang LEE, Seoul (KR)

(73) Assignee: LG ELECTRONICS INC., Yeongdeungpo-gu (KR)

(21) Appl. No.: 16/681,568

(22) Filed: Nov. 12, 2019

(30) Foreign Application Priority Data
Apr. 4, 2019 (KR) 10-2019-0039793

(51) Int. Cl. B01D 45/16; F25B 5/02; F04D 13/06; F04D 29/42

(52) U.S. Cl. CPC B01D 45/16; F04D 29/422; F04D 13/0626; F25B 5/02

(57) ABSTRACT

An electric compressor is disclosed. An electric compressor includes an oil separating member to effectively separate oil mixed in a compressed refrigerant. The oil separating member includes a compression guide part and an exhaust guide part. The oil mixed in the compressed refrigerant is separated by colliding with the compression guide part and the exhaust guide part. The compression guide part and the exhaust guide part form a refrigerant exhaust passage. The exhaust passage may have a diversified shape, such as a zigzag shape or a maze shape. The oil mixed in the compressed refrigerant is separated by its own weight while flowing through the exhaust passage. Accordingly, oil separation efficiency of the electric compressor can be improved.

### CROSS-REFERENCE TO RELATED APPLICATION

Pursuant to 35 U.S.C. § 119(a), this application claims the benefit of an earlier filing date of and the right of priority to Korean Application No. 10-2019-0039793, filed on Apr. 4, 2019, the contents of which are incorporated by reference herein in their entirety.

### BACKGROUND OF THE DISCLOSURE

### 1. Field of the Disclosure

The present disclosure relates to an electric compressor (motor-operated compressor), and more particularly, to an electric compressor having a structure capable of efficiently separating oil mixed in a compressed refrigerant.

### 2. Background of the Disclosure

Compressors serving to compress refrigerant in air conditioning systems for vehicles have been developed in various forms. In recent years, electric compressors (motor-operated compressors) driven by electric power using motors have been actively developed.

For example, an electric compressor generally employs a scroll-compression method which is suitable for a high compression ratio operation. Such a scroll-type electric compressor (hereinafter, referred to as “electric compressor”) includes a motor unit, a compression unit, and a rotating shaft connecting the motor unit and the compression unit.

Specifically, the motor unit is configured as a rotary motor or the like, and installed inside a hermetic casing. The compression unit is located at one side of the motor unit, and is provided with a fixed scroll and an orbiting scroll. The rotating shaft is configured to transmit rotational force of the motor unit to the compression unit.

The refrigerant compressed in the compression unit is exhausted to outside of the electric compressor through an exhaust port. The exhausted refrigerant is utilized for operating an air conditioning system for vehicle.

Currently, lubricating oil or the like is generally supplied to the electric compressor so that the refrigerant can be compressed smoothly. However, during the refrigerant compression process, lubricating oil and the refrigerant may be mixed.

When lubricating oil is mixed with refrigerant for driving a refrigeration cycle, it may cause not only a malfunction of the refrigeration cycle but also deterioration of refrigerating efficiency of the refrigeration cycle.

However, adding a process for separating the lubricant and the refrigerant during the refrigerant compression process is not preferable in view of refrigerant compression efficiency of the entire compressor.

In order to solve this problem, electric compressors have been known to use centrifugal separation. That is, a cylindrical oil separator is disposed in a compression chamber of the electric compressor. Accordingly, refrigerant introduced into the compression chamber flows along the centrifugal oil separator while performing an orbiting motion.

During this process, oil particles of great mass are separated from the refrigerant by centrifugal force which is generated by the orbiting motion. The separated oil flows down to be supplied back into the compressor, while the oil-separated refrigerant is exhausted to outside of the electric compressor through an exhaust port formed on an upper side.

However, the centrifugal separator described above has the following limitations.

First, the centrifugal separation is affected by the size of a cylinder. That is, as the size of the cylinder becomes larger, a space in which the refrigerant can perform the orbiting motion becomes larger. Thus, oil separation efficiency can be improved.

However, the size increase of the cylinder results in a size increase of the electric compressor, and thereby the size of the cylinder cannot be increased without limit. That is, there is a limit in improvement of oil separation efficiency.

Also, due to the size problem of the cylinder and the electric compressor, there is a limit in increasing the capacity of the electric compressor.

That is, when a compression capacity of the electric compressor is increased, an amount of refrigerant compressed for the same period of time is increased. Oil separation efficiency must be improved in order to separate oil mixed with the increased refrigerant for the same period of time.

However, as described above, when the centrifugal separation is applied, there is a limit in increasing the size of the cylinder. Therefore, the capacity increase of the electric compressor is limited due to the size limitation of the cylinder.

In addition, when the size of the cylinder is increased to enhance the oil separation efficiency in the centrifugal separation manner, pressure drop of the compressed refrigerant is increased by the increased size of the cylinder.

Considering that the electric compressor is employed to drive a refrigeration cycle or the like by compressing the refrigerant, the pressure drop of the compressed refrigerant may make it difficult to achieve the fundamental purpose of the electric compressor.

Accordingly, technologies for improving the oil separation efficiency by providing a separate member or the like in the cylindrical oil separator using the centrifugal separation method have been introduced. Korean Registration Patent Application No. 10-0203972 discloses a compressor having a structure for improving oil separation efficiency by using a separate member provided inside a discharge port. In detail, a compressor having a structure in which a cylindrical oil-separating container is disposed inside a discharge port so that compressed refrigerant can effectively perform an orbiting motion toward the discharge port is disclosed.

However, this type of compressor still uses the centrifugal separation method, and the installation of the oil-separating container may facilitate the orbiting motion, but a space in which the refrigerant can perform the orbiting motion is reduced due to the oil-separating container. Korean Publication Patent Application No. 10-2018-0124633 discloses a scroll compressor having a separate oil separating member. Specifically, a scroll compressor having a structure in which oil can be separated before refrigerant is discharged by providing a mesh-shaped oil-separating member between a refrigerant discharge pipe through which compressed refrigerant is discharged and a compression chamber is disclosed.

However, this structure separates the oil only depending on the shape of the mesh member, which may lower the oil separation efficiency as compared to the centrifugal separation method. In addition, there is a limit to an amount that oil separation efficiency may be lowered when oil particles are stuck on the mesh member as the scroll compressor is kept driven.

### PATENT DOCUMENTS

Korean Registration Patent Application No. 10-0203972 (Jun. 15, 1999) Korean Patent Laid-Open Publication No. 10-2018-0124633 (Nov. 21, 2018)

### SUMMARY OF THE DISCLOSURE

The present disclosure is directed to providing an electric compressor having a structure capable of solving the above-mentioned problems.

One aspect of the present disclosure is to provide an electric compressor having a structure capable of effectively separating oil mixed in a compressed refrigerant without requiring a larger space.

Another aspect of the present disclosure is to provide an electric compressor having a structure capable of forming a refrigerant exhaust passage through which oil mixed with a compressed refrigerant can be effectively separated.

Still another aspect of the present disclosure is to provide an electric compressor having a structure capable of effectively separating oil mixed in a compressed refrigerant without greatly changing a structure of a compression chamber and an exhaust port through which the refrigerant is exhausted.

Still another aspect of the present disclosure is to provide an electric compressor having a structure, capable of effectively separating oil mixed in a compressed refrigerant and of being easily manufactured and maintained.

Still another aspect of the present disclosure is to provide an electric compressor having a structure capable of improving collision efficiency between refrigerant and an inner wall of a compression chamber to facilitate separation of oil mixed in the compressed refrigerant.

Still another aspect of the present disclosure is to provide an electric compressor having a structure capable of effectively collecting oil which has been separated from a compressed refrigerant.

Still another aspect of the present disclosure is to provide an electric compressor having a structure, capable of separating oil mixed with a compressed refrigerant not only by a collision method but also a filtration method using particle sizes.

Still another aspect of the present disclosure is to provide an electric compressor having a structure, capable of separating oil mixed with a compressed refrigerant by inducing an additional collision as well as through a refrigerant exhaust passage.

To achieve those aspects and other advantages according to the present disclosure, there is provided an electric compressor, including a compression unit including a fixed scroll and an orbiting scroll configured to rotate relative to the fixed scroll, the compression unit configured to compress a refrigerant by a relative rotation of the orbiting scroll, and a rear housing located opposite to the orbiting scroll and coupled to the fixed scroll to form a predetermined space, wherein the fixed scroll comprises a compression guide part protruding from one side thereof facing the rear housing, and forms an exhaust passage for the compressed refrigerant, and wherein the rear housing comprises an exhaust guide part protruding from one side thereof facing the fixed scroll, and forms the exhaust passage for the compressed refrigerant.

Also, the compression guide part of the electric compressor may cover at least part of an outer circumferential surface of the exhaust guide part.

The compression guide part and the exhaust guide part of the electric compressor each has a cylindrical shape with a hollow portion formed therein, and the exhaust guide part may be at least partially inserted into the hollow portion of the compression guide part.

The compression guide part and the exhaust guide part each has a polygonal shape with a hollow portion formed therein, and the exhaust guide part may be at least partially inserted into the hollow portion of the compression guide part.

The compression guide part and the discharge guide portion of the electric compressor each includes a hollow portion therein, and has a shape of a column with at least one curved side surface, and the exhaust guide part may be at least partially inserted into the hollow portion of the compression guide part.

The exhaust guide part of the electric compressor may be inserted into the hollow portion of the compression guide part so that an outer circumferential surface of the exhaust guide part is spaced apart by a predetermined distance from an inner circumferential surface of the compression guide part.

The exhaust passage of the refrigerant in the electric compressor may include the predetermined space, and a space formed between the outer circumferential surface of the exhaust guide part and the inner circumferential surface of the compression guide part spaced apart from each other.

The fixed scroll and the orbiting scroll may be spaced apart from each other by a predetermined distance so that a space for compressing the refrigerant is formed between the fixed scroll and the orbiting scroll. The fixed scroll includes a discharge port through which the space for compressing the refrigerant and the compression guide part communicate with each other, and the discharge port may be located lower than the compression guide part and the exhaust guide part in a downward direction.

The rear housing includes an exhaust port through which the predetermined space and an outside of the rear housing communicate with each other, and the exhaust guide part may be disposed such that the hollow portion of the exhaust guide part communicates with the exhaust port.

The exhaust guide part of the electric compressor includes an exhaust mesh member disposed on one end portion thereof facing the fixed scroll, and a plurality of filtering holes for separating oil mixed with the compressed refrigerant.

The rear housing includes a separation protruding portion protruding from one side thereof facing the fixed scroll, so that oil mixed with the compressed refrigerant is separated as the compressed refrigerant collides with the separation protruding portion.

The separation protruding portion of the electric compressor may have one side surface, facing the fixed scroll, formed to be inclined downward in a downward direction.

The fixed scroll and the orbiting scroll of the electric compressor may be spaced apart from each other by a predetermined distance so that a space for compressing the refrigerant is formed between the fixed scroll and the orbiting scroll. The fixed scroll may be provided with a discharge port formed therethrough such that the space for compressing the refrigerant and the compression guide part communicate with each other, and the separation protruding portion may be located on a virtual line extending from the discharge port.

The fixed scroll and the orbiting scroll of the electric compressor may be spaced apart from each other by a predetermined distance so that a space for compressing the refrigerant is formed between the fixed scroll and the orbiting scroll. The fixed scroll may be provided with a discharge port formed therethrough such that the space for compressing the refrigerant and the compression guide part communicate with each other, and the discharge port includes a discharge mesh member disposed on one side thereof facing the fixed scroll, and a plurality of filtering holes for separating oil mixed with the compressed refrigerant.

The compression guide part of the electric compressor includes a compression flange protruding from an outer circumferential surface of the compression guide part, and the exhaust guide part includes an exhaust flange protruding from an outer circumferential surface of the exhaust guide part.

The rear housing includes an oil exhaust passage formed in a lower side thereof through which the oil separated from the compressed refrigerant is exhausted.

According to the present disclosure, the following effects can be achieved.

First, oil mixed in a compressed refrigerant is separated from the refrigerant by collision with an inner wall of a discharge chamber.

Therefore, the separation of the refrigerant and the oil can be effectively carried out even when the discharge chamber is formed as a small space as compared with a centrifugal separation method.

Also, exhaust passage forming members protrude from a fixed scroll and a rear housing, respectively, so as to form an exhaust passage of a compressed refrigerant. An exhaust passage may not be formed in a linear shape but in a maze shape like a zigzag path. As a result, a path along which the refrigerant moves to be exhausted can be increased in length, which may result in securing a sufficient time for separating the oil mixed in the compressed refrigerant.

Therefore, the oil mixed in the compressed refrigerant can be effectively separated.

The exhaust passage forming member protruding from the fixed scroll is formed independently of a refrigerant discharge port formed in the fixed scroll. That is, the exhaust passage forming member does not affect any of structure and shape of the discharge port of the refrigerant.

In addition, the exhaust passage forming member protruding from the rear housing is formed independently of a refrigerant exhaust port formed in the rear housing. That is, the exhaust passage forming member does not affect any of structure and shape of the exhaust port of the refrigerant.

Therefore, the oil mixed in the compressed refrigerant can be effectively separated without greatly changing the structure of the discharge chamber and the structure of the exhaust port through which the refrigerant is exhausted.

Also, the exhaust passage forming member provided in the fixed scroll and the exhaust passage forming member provided in the rear housing are formed independently of each other. The exhaust passage forming member provided in the rear housing is inserted into a hollow portion formed in the exhaust passage forming member provided in the fixed scroll. This coupling does not require a separate coupling member.

Accordingly, an exhaust passage for effectively separating the oil mixed in the compressed refrigerant can be formed and manufacturing and maintenance can be simplified.

In addition, a member for inducing collision is formed by protruding from an inner wall of the rear housing forming the discharge chamber. The refrigerant discharged from the discharge port of the fixed scroll collides with the member for inducing the collision.

Therefore, a path until the refrigerant discharged from the fixed scroll to the discharge chamber collides with the inner wall of the discharge chamber can be shortened in length. In addition, since a surface area of the inner wall of the discharge chamber is increased due to the shape of the protruded member, refrigerant collision efficiency is improved.

The member for inducing the collision may be inclined downward. Therefore, a mixed fluid of the refrigerant and the oil discharged into the discharge chamber can collide with the member for inducing the collision, and then the oil is induced to fall downward.

As a result, the oil mixed in the compressed refrigerant can be separated and then easily collected in a lower side of the discharge chamber.

A mesh may be provided on the discharge port of the fixed scroll or an end portion of the exhaust passage forming member provided in the rear housing.

Therefore, the mixed fluid of the refrigerant and the oil can be separated not only by the collision with the inner wall of the discharge chamber but also by the mesh. This may result in improving oil separation efficiency from the compressed refrigerant.

The exhaust passage forming member provided in the fixed scroll or the exhaust passage forming member provided in the rear housing may be provided with a flange for inducing additional collision.

Therefore, additional collision of the refrigerant with the flange while the refrigerant flows toward the exhaust port can be induced, which may result in further enhancing the oil separation efficiency from the compressed refrigerant.

### BRIEF DESCRIPTION OF THE DRAWINGS

FIG. 1 is a perspective view of an electric compressor in accordance with one embodiment of the present disclosure.

FIG. 2 is an exploded perspective view of the electric compressor of FIG.

FIG. 3 is a cross-sectional view of the electric compressor of FIG. 1.

FIG. 4 is a cross-sectional perspective view illustrating a fixed scroll and a rear housing having an oil separating member in accordance with one embodiment of the present disclosure.

FIG. 5 is a perspective view illustrating the oil separating member provided in the fixed scroll of FIG. 3.

FIG. 6 is a perspective view illustrating a fixed scroll including an oil separating member in accordance with another embodiment of the present disclosure.

FIG. 7 is a perspective view illustrating a fixed scroll including an oil separating member in accordance with still another embodiment of the present disclosure.

FIG. 8 is a perspective view illustrating an oil separating member provided in the rear housing of FIG. 3.

FIG. 9 is a perspective view illustrating a rear housing including an oil separating member in accordance with another embodiment of the present disclosure.

FIG. 10 is a perspective view illustrating a rear housing including an oil separating member in accordance with still another embodiment of the present disclosure.

FIG. 11 is a perspective view illustrating an oil separating member provided in the fixed scroll of FIG. 3 and including an exhaust mesh member.

FIG. 12 is a perspective view illustrating a rear housing including a separation protruding portion in accordance with one embodiment of the present disclosure.

FIG. 13 is a perspective view illustrating a rear housing including a separation protruding portion in accordance with another embodiment of the present disclosure.

FIG. 14 is a cross-sectional perspective view illustrating a fixed scroll and a rear housing including a flange portion in accordance with one embodiment of the present disclosure.

FIG. 15 is a perspective view illustrating a process of separating refrigerant and oil from each other in an electric compressor having an oil separating member in accordance with one embodiment of the present disclosure.

FIG. 16 is a perspective view illustrating a process of separating refrigerant and oil from each other in an electric compressor having a separation protruding portion in accordance with one embodiment of the present disclosure.

FIG. 17 is a perspective view illustrating a process of separating refrigerant and oil from each other in an electric compressor having a separation protruding portion in accordance with another embodiment of the present disclosure.

FIG. 18 is a perspective view illustrating a process of separating refrigerant and oil from each other in an electric compressor including an exhaust mesh member and a discharge mesh member in accordance with one embodiment of the present disclosure.

FIG. 19 is a perspective view illustrating a process of separating refrigerant and oil from each other in an electric compressor having a flange portion in accordance with one embodiment of the present disclosure.

FIG. 20 is a perspective view illustrating a process of separating refrigerant and oil from each other in an electric compressor having an oil separating member in accordance with one embodiment of the present disclosure.

### DETAILED DESCRIPTION OF THE DISCLOSURE

Hereinafter, an electric compressor (motor-operated compressor) 10 according to one embodiment of the present disclosure will be described in detail with reference to the accompanying drawings.

In the following description, a description of some components may be omitted in order to clarify the technical characteristics of the present disclosure.

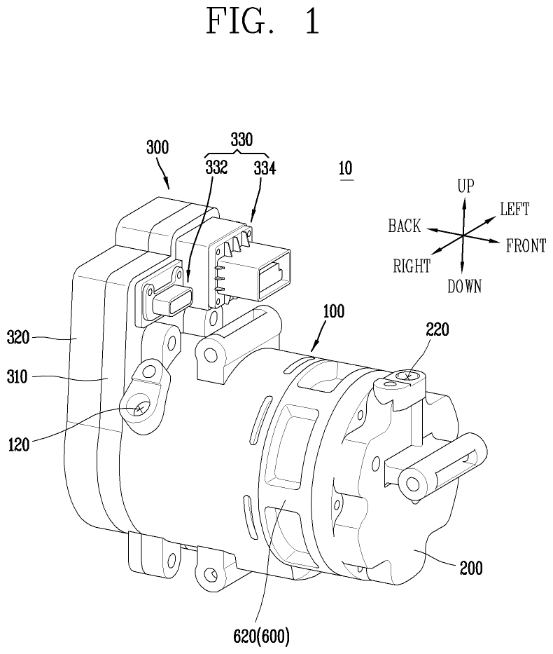

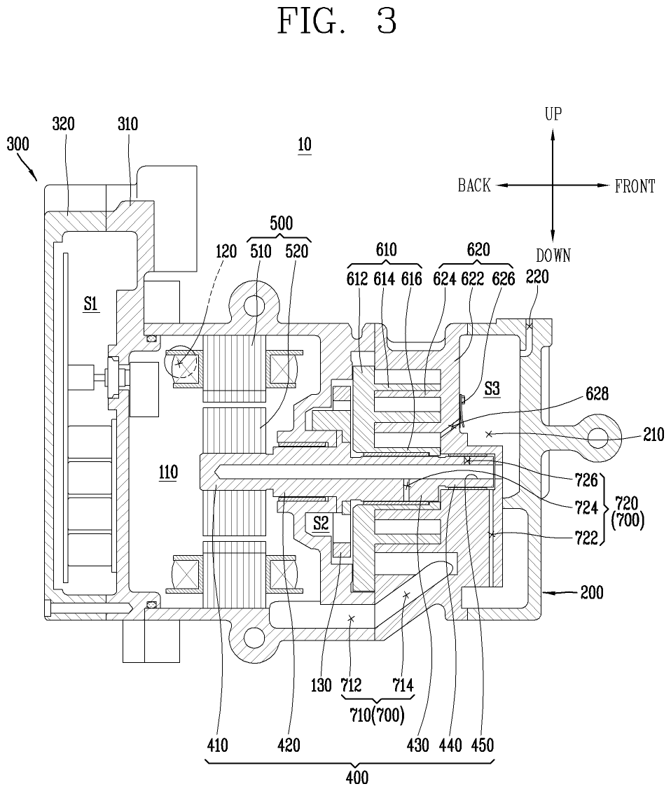

The terms “front side”, “rear side”, “upper side”, “lower side”, “right side”, and “left side” used in the following description will be understood with reference to a coordinate system shown in FIGS. 1, 3, and 4.

It will be understood that when an element is referred to as being “connected with” another element, the element can be connected with the another element or intervening elements may also be present.

In contrast, when an element is referred to as being “directly connected with” another element, there are no intervening elements present.

A singular representation may include a plural representation unless it represents a definitely different meaning from the context.

The term “refrigerant” used in the following description refers to an arbitrary medium that takes heat from an object of low temperature and transfers the heat to an object of high temperature. In one embodiment, a refrigerant may be carbon dioxide (CO₂), R134a, R1234yf, and the like.

The term “oil” used in the following description is used for the purpose of preventing or dispersing heat or abrasion, which is generated or caused on a rubbed portion of a machine, and refers to an arbitrary fluid which can be mixed with or separated from refrigerant. In one embodiment, oil may be lubricating oil (or a lubricant).

The term “mixed fluid” used in the following description refers to a fluid that oil and refrigerant compressed in a compression unit 600 to be explained later are mixed with each other.

The term “exhaust passage” used in the following description refers to a passage or flow path through which a fluid is exhausted to outside of the electric compressor 10. A compressed refrigerant or a mixed fluid of the compressed refrigerant and oil may flow along an exhaust passage.

The term “oil separation efficiency” used in the following description refers to efficiency with which oil is separated from a mixed fluid. Oil separation efficiency may be quantified by an amount of oil separated from a mixed fluid until the mixed fluid is exhausted through an exhaust port.

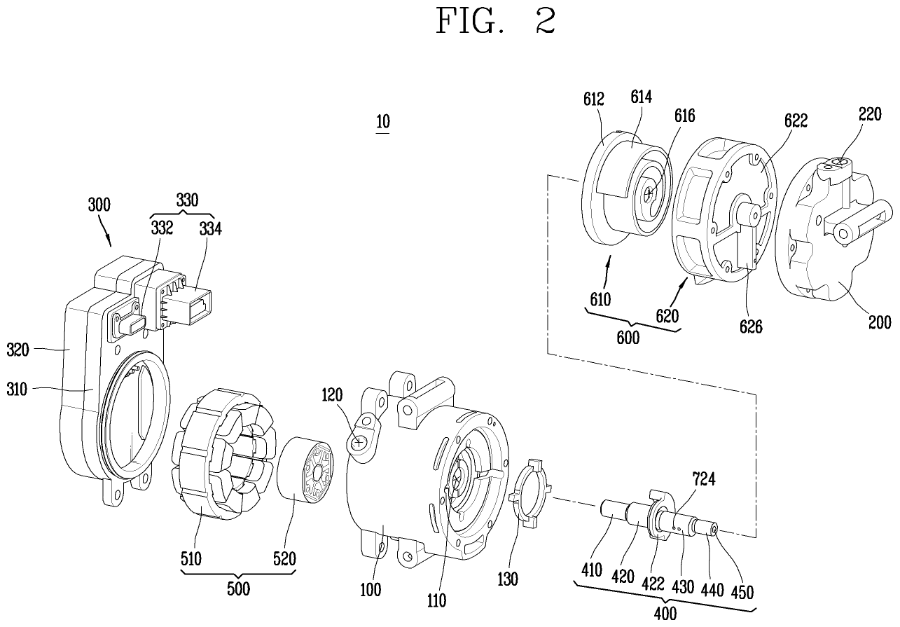

Referring to FIGS. 1 to 3, an electric compressor 10 according to an embodiment of the present disclosure includes a main housing 100, a rear housing 200, an inverter unit 300, a rotating shaft unit 400, a motor unit 500, a compression unit 600, and a passage unit 700.

Further, the electric compressor 10 according to the embodiment of the present disclosure further includes an oil separating member 800 for effectively separating oil from a mixed fluid.

Hereinafter, each configuration of the electric compressor 10 according to the embodiment of the present disclosure will be described with reference to FIGS. 1 to 3, and the oil separating member 800 will be described separately.

The main housing 100 defines a part of appearance of the electric compressor 10. In addition, the main housing 100 forms a body of the electric compressor 10, and a space is formed in the main housing 100 to accommodate therein devices or components provided in the electric compressor 10.

Specifically, the rotating shaft unit 400, the motor unit 500, and the compression unit 600 may be accommodated in the inner space of the main housing 100.

The main housing 100 is formed in a cylindrical shape which is long in a lengthwise direction, namely, in a back-and-forth (front-rear) direction in the illustrated embodiment. The main housing 100 may have an arbitrary shape that can accommodate therein devices or components of the electric compressor 10.

However, considering that a refrigerant introduced into the main housing 100 is compressed to high pressure, the main housing 100 is preferably formed in a cylindrical shape having high pressure resistance.

A fixed scroll 620 of the compression unit 600 which is to be described later is connected to one side of the main housing 100 in the lengthwise direction of the main housing 100, namely, to a front side of the main housing 100 in the illustrated embodiment, so that a fluid can flow.

A refrigerant introduced into the main housing 100 is compressed by the compression unit 600 and then flows into a discharge chamber S3 through a discharge port 628 formed in the fixed scroll 620.

An inverter unit 300 to be explained later is connected to another side of the main housing 100 in the lengthwise direction, namely, to a rear side in the embodiment so that currents can flow.

Power and control signal applied from the inverter unit 300 are transmitted to the motor unit 500, so that the motor unit 500 is controlled to generate rotational force for the compression unit 600 to compress a refrigerant.

The main housing 100 includes a motor room 110, an intake port 120, and an Oldham ring 130.

The motor room 110 is a space in which the motor unit 500 is accommodated. The motor room 110 may be defined as an inner space of the main housing 100.

The motor room 110 is defined by an inner surface of the main housing 100. That is, the motor room 110 is a space surrounded by the inner surface of the main housing 100.

When the motor unit 500 is accommodated in the motor room 110, an outer surface of a stator 510 of the motor unit 500 may be fixed to the inner surface of the main housing 100. Accordingly, even if power and control signal are applied from the inverter unit 300 to the motor unit 500, the stator 510 may not rotate.

The intake port 120 communicates inside and outside of the main housing 100. A refrigerant may be introduced into the main housing 100 through the intake port 120. The introduced refrigerant is compressed while sequentially passing through the motor room 110, a back pressure chamber S2 and the discharge chamber S3, and then exhausted to outside of the electric compressor 10 through an exhaust port 220 to be explained later.

The intake port 120 is located on an outer circumferential surface of one side of the main housing 100, namely, a rear side of the main housing 100 in the illustrated embodiment, which is opposite to the fixed scroll 620 and the rear housing 200.

The intake port 120 is also formed as a circular through hole penetrating through outside and inside of the main housing 100.

The position and shape of the intake port 120 may be determined as arbitrary position and shape which allow communication between the inside and the outside of the main housing 100.

However, considering the fact that a large amount of heat is generated in an inverter device accommodated in the inverter unit 300 to be described later and the fact that the refrigerant introduced into the main housing 100 serves to cool the generated heat, the intake port 120 is preferably located adjacent to the inverter unit 300.

The Oldham ring 130 is provided between the main housing 100 and an orbiting scroll 610 of the compression unit 600 to be described later.

The Oldham ring 130 prevents rotation of the orbiting scroll 610. Further, the Oldham ring 130 transmits the rotational force of the motor unit 500, which is transmitted by the rotating shaft unit 400 to be described later, to the orbiting scroll 610.

To this end, the Oldham ring 130 is integrally coupled to the rotating shaft unit 400 and the orbiting scroll 610 so as to be rotatable together. In other words, the Oldham ring 130 is fixedly coupled to the rotating shaft unit 400 and the orbiting scroll 610, respectively.

Accordingly, when the motor unit 500 is operated, the Oldham ring 130, the rotating shaft unit 400, and the orbiting scroll 610 can be rotated integrally.

As a result, the Oldham ring 130 allows the orbiting scroll 610 to be rotated only when the motor unit 500 is operated.

Although not illustrated, a rotation-preventing mechanism (not shown), including a pin and a ring, may be provided, instead of the Oldham ring 130.

The Oldham ring 130 may be replaced with any member which is configured to prevent rotation of the orbiting scroll 610 and rotate the rotating shaft unit 400 and the orbiting scroll 610 integrally.

The rear housing 200 defines a part of appearance of the electric compressor 10. Specifically, the rear housing 200 is located at one side of the main housing 100, namely, the front side of the main housing 100 in the illustrated embodiment, so as to define the appearance of the electric compressor 10 together with the main housing 100.

The fixed scroll 620 of the compression unit 600 to be described later is positioned between the rear housing 200 and the main housing 100. That is, the main housing 100, the fixed scroll 620, and the rear housing 200 are sequentially connected to enable a flow of fluid.

Alternatively, the fixed scroll 620 may be configured to be accommodated in the main housing 100. In this case, the rear housing 200 may be directly connected to the main housing 100.

The rear housing 200 is configured to communicate with the main housing 100. The refrigerant introduced into the main housing 100 through the intake port 120 of the main housing 100 may be compressed in the compression unit 600 and then introduced into the rear housing 200.

In the illustrated embodiment, the rear housing 200 is formed in a shape of a cap having a circular cross section. The shape of the rear housing 200 may be changed, but is preferably changed to correspond to the shape of the main housing 100 and the shape of the fixed scroll 620.

The rear housing 200 includes a space portion 210, an exhaust port 220, and an oil exhaust passage 230.

The space portion 210 is defined as one side surface of the rear housing 200 and is recessed. Specifically, the space portion 210 is a recessed portion of one side surface of the rear housing 200 which faces the fixed scroll 620.

As described above, the one side of the rear housing 200, namely, the rear side of the rear housing in the illustrated embodiment is coupled to the fixed scroll 620 so that a fluid can flow.

At this time, the discharge chamber S3 may be defined by one surface of the fixed scroll 620 facing the rear housing 200 and the space portion 210. The discharge chamber S3 is defined as a space formed at an upper side, of spaces between the rear housing 200 and the fixed scroll 620.

The refrigerant compressed in the compression unit 600 flows into the discharge chamber S3. Specifically, a mixed fluid in which oil supplied to the compression unit 600 and the compressed refrigerant are mixed flows into the discharge chamber S3.

The mixed fluid introduced into the discharge chamber S3 is exhausted to outside of the electric compressor 10 through the exhaust port 220 after oil separation is executed. The separated oil may be re-supplied to the compression unit 600 through the oil exhaust passage 230 to be described later.

The exhaust port 220 is a passage through which the compressed refrigerant is exhausted to the outside of the electric compressor 10. The exhaust port 220 communicates the inside and the outside of the rear housing 200. Specifically, the exhaust port 220 communicates the outside of the rear housing 200 with the discharge chamber S3.

In one embodiment, the exhaust port 220 may be formed as a through hole.

In the illustrated embodiment, the exhaust port 220 is formed in an upper side of the rear housing 200. The position of the exhaust port 220 may be changed to an arbitrary position at which it can communicate the inside and the outside of the rear housing 200.

As described above, the main housing 100, the rear housing 200, and the compression unit 600 to be described later are connected to communicate with one another. Therefore, the refrigerant introduced into the electric compressor 10 through the intake port 120 can be compressed in the compression unit 600 and then exhausted to the outside of the electric compressor 10 through the exhaust port 220.

The oil exhaust passage 230 is a passage through which oil separated from the mixed fluid is discharged from the discharge chamber S3.

The oil exhaust passage 230 communicates the discharge chamber S3 with the outside of the rear housing 200. In detail, the oil exhaust passage 230 communicates the discharge chamber S3 with an oil chamber (not shown) of the electric compressor.

The oil separated from the mixed fluid in the discharge chamber S3 may be discharged through the oil exhaust passage 230 and collected in the oil chamber (not shown).

The oil collected in the oil chamber (not shown) may be supplied to the compression unit 600 through an oil passage portion 720 of a passage unit 700 to be described later, so as to be used as lubricating oil for smooth rotation of the orbiting scroll 610.

In the illustrated embodiment, the oil exhaust passage 230 is located on a lower side of the rear housing 200. This is because the oil separated from the mixed fluid drops downward due to density difference.

The rear housing 200 may be provided with an oil separating member 800 to be described later. The oil separating member 800 makes it possible to effectively separate the oil from the mixed fluid. A detailed description thereof will be given later.

The inverter unit 300 receives from outside power and control signal for driving the electric compressor 10, specifically, the motor unit 500 to be described later, and applies the received power and control signal to the motor unit 500.

To this end, the inverter unit 300 may accommodate an inverter device (not shown), which includes an insulated bipolar transistor (IGBT) and the like, in an inner space thereof.

The inverter unit 300 is located on one side of the main housing 100. The inverter unit 300 is located on one side of the main housing 100 opposite to the rear housing 200, namely, on the rear side of the main housing 100 in the illustrated embodiment.

The inverter unit 300 may be disposed at any position where it can receive power and control signal from outside and applies them to the motor unit 500.

The inverter unit 300 is connected to the main housing 100 so that currents can flow. By the connection, the inverter unit 300 can apply the power and the control signal to the motor unit 500.

Although not illustrated, the inverter unit 300 and the main housing 100 may communicate with each other. In this embodiment, the refrigerant introduced through the intake port 120 may directly cool the inverter device (not illustrated) accommodated in the inverter unit 300.

The inverter unit 300 includes an inverter housing 310, an inverter cover 320, and a connector portion 330. Although not shown, an inverter device (not shown) may be provided in the inverter unit 300 as described above.

The inverter housing 310 forms appearance of the inverter unit 300 together with the inverter cover 320. An inner space formed by coupling the inverter housing 310 and the inverter cover 320 may be defined as an inverter room S1 in which an inverter device (not shown) is accommodated.

The inverter housing 310 is coupled to the main housing 100. In the illustrated embodiment, the inverter housing 310 and the main housing 100 do not communicate with each other.

Therefore, the inverter housing 310 may be formed of a material having good thermal conductivity so that heat generated in the inverter device (not shown) accommodated in the inverter unit 300 can be cooled. Accordingly, the inverter device (not shown) accommodated in the inverter unit 300 can be cooled by the refrigerant introduced into the main housing 100.

The inverter cover 320 is located on one side of the inverter housing 310 opposite to the main housing 100, namely, on the rear side of the inverter housing 310 in the illustrated embodiment.

The inverter cover 320 is coupled with the inverter housing 310 to form an appearance of the inverter unit 300. The inverter device (not shown) is accommodated in the inverter room S1, which is formed by coupling the inverter cover 320 and the inverter housing 310 to each other.

The inverter cover 320 may be coupled to the inverter housing 310 by a separate coupling member (not shown).

The connector portion 330 is a portion to which power and control signal are input from the outside. The power and control signal applied to the connector portion 330 are transmitted to the motor unit 500 to generate rotational force for the electric compressor 10 to compress the refrigerant.

In the illustrated embodiment, the connector portion 330 is located on a front upper side of the inverter housing 310. The connector portion 330 may be provided at an arbitrary position at which power and control signal can be received from the outside.

The connector portion 330 includes a communication connector 332 for receiving a control signal and a power connector 334 for receiving power. Alternatively, the connector portion 330 may be provided with a single connector to receive both power and control signal.

The process of controlling the motor unit 500 by applying power and control signal to the inverter device (not shown) accommodated in the inverter room S1 through the connector portion 330 is a well-known technology, and thus a detailed description thereof will be omitted.

The rotating shaft unit 400 transfers rotational force generated by the rotation of the motor unit 500 to the orbiting scroll 610.

To this end, a rotor 520 of the motor unit 500 is coupled to one side of the rotating shaft unit 400, namely, a rear side of the rotating shaft unit 400 in the illustrated embodiment. Also, another side of the rotating shaft unit 400, namely, the front side thereof in the illustrated embodiment, is coupled to the orbiting scroll 610.

In the illustrated embodiment, the rotating shaft unit 400 may be formed in a cylindrical shape extending in a lengthwise direction thereof, and the shape may be an arbitrary shape capable of transferring the rotational force of the motor unit 500 to the compression unit 600.

The rotating shaft unit 400 includes a shaft portion 410, a main bearing portion 420, an eccentric portion 430, a sub bearing portion 440, and an oil supply guide passage 450.

The shaft portion 410 is rotatably coupled to the rotor 520 of the motor unit 500. The shaft portion 410 is located on one side of the rotating shaft unit 400 adjacent to the rotor 520.

The main bearing portion 420 is rotatably supported in a radial direction by a shaft coupling portion (not shown) provided in the main housing 100. In other words, the main bearing portion 420 is a portion where the rotating shaft unit 400 is coupled to the main housing 100.

To this end, the main bearing portion 420 is formed to have a larger radius than the shaft portion 410. In addition, the main bearing portion 420 is located on one side of the shaft portion 410, namely, a front side of the shaft portion 410 opposite to the rotor 520 in the illustrated embodiment.

A balance weight 422 is provided on a front side of the main bearing portion 420. The balance weight 422 may adjust a center of gravity of the rotating shaft portion 400 so that the rotating shaft unit 400 can be stably rotated in response to the rotation of the motor unit 500.

The eccentric portion 430 is rotatably coupled to the rotating shaft coupling portion 616 of the orbiting scroll 610 of the compression unit 600. The eccentric portion 430 is formed to have a central axis different from that of the rotating shaft unit 400. In other words, when the rotating shaft unit 400 is rotated, the eccentric portion 430 is rotated centering on the central axis different from the central axis of the rotating shaft unit 400.

Accordingly, the orbiting scroll 610 coupled to the eccentric portion 430 can also be eccentrically rotated relative to the rotation of the motor unit 500. As a result, the refrigerant can be compressed in a space between an orbiting wrap 614 of the orbiting scroll 610 and a fixed wrap 624 of the fixed scroll 620.

For this eccentric rotation, the eccentric portion 430 may be formed such that a center of gravity of its cross section is different from the central axis of the rotating shaft unit 400.

The eccentric portion 430 is located on one side of the main bearing portion 420, namely, a front side of the main bearing portion 420 opposite to the shaft portion 410 in the illustrated embodiment.

A second oil passage 724, which will be described later, is formed through an outer circumferential surface of the eccentric portion 430. Oil separated from the compressed refrigerant may be resupplied to the compression unit 600 through the second oil passage 724. A detailed description thereof will be given later.

The sub bearing portion 440 is rotatably coupled to the rotating shaft coupling portion (not shown) of the fixed scroll 620 of the compression unit 600 and is supported in the radial direction. The sub bearing portion 440 may be inserted through the rotating shaft coupling portion 616 of the orbiting scroll 610.

In detail, the eccentric portion 430 is coupled through the rotating shaft coupling portion 616 formed on the orbiting plate portion 612 of the orbiting scroll 610. The sub bearing portion 440 is inserted through the rotating shaft coupling portion 616 of the orbiting scroll 610 so as to be rotatably coupled to a rotating shaft coupling portion (not shown) of the fixed scroll 620.

In the illustrated embodiment, the sub bearing portion 440 is formed to have a smaller radius than the eccentric portion 430. Therefore, the sub bearing portion 440 is not constrained in the radial direction by the rotating shaft coupling portion 616 of the orbiting scroll 610.

The sub bearing portion 440 is located on one side of the eccentric portion 430, namely, a front side of the eccentric portion which is opposite to the main bearing portion 420 in the illustrated embodiment.

The oil supply guide passage 450 is a passage through which the oil separated from the compressed refrigerant flows into the third oil passage 726. To this end, the oil supply guide passage 450 communicates with the third oil passage 726 and a first oil passage 722.

The oil supply guide passage 450 may be formed through the sub bearing portion 440 in a lengthwise direction of the sub bearing portion 440, namely, in a front-rear direction in the illustrated embodiment. In an embodiment, the oil supply guide passage 450 may be formed on a central axis of the sub bearing portion 440.

The motor unit 500 is accommodated in the motor room 110 of the main housing 100 to supply power for the compressing part 600 to compress a refrigerant.

The motor unit 500 may be operated and controlled by power and control signal applied from the inverter unit 300. For this purpose, the motor unit 500 and the inverter unit 300 may be connected so that currents can flow.

The motor unit 500 is rotatably connected to the rotating shaft unit 400. Specifically, the motor unit 500 is connected to the rotating shaft unit 400 so that the rotating shaft unit 400 can also be rotated when the motor unit 500 is rotated.

Rotational force generated in the motor unit 500 may be transmitted to the orbiting scroll 610 of the compression unit 600 through the rotating shaft unit 400.

The motor unit 500 includes a stator 510 and a rotor 520.

When power is applied to the motor unit 500, the stator 510 is not rotated and the rotor 520 is rotated relative to the stator 510. The rotational force generated by the rotation of the rotor 520 is transmitted to the orbiting scroll 610 through the rotating shaft unit 400.

The stator 510 forms a magnetic field required for driving the motor unit 500 according to the power and control signal applied from the inverter unit 300. As the magnetic field is formed by the stator 510, magnets (not shown) provided in the rotor 520 may be rotated by receiving electromagnetic force.

The stator 510 may include a plurality of coils (not shown). When power and control signal are applied from the inverter unit 300, the plurality of coils (not shown) forms a magnetic field.

The magnetic field formed by the plurality of coils (not shown) applies electromagnetic force to a plurality of magnets (not shown) provided in the rotor 520. At this time, the plurality of coils (not shown) are preferably arranged in a manner that the plurality of magnets (not shown) receives the electromagnetic force in the same direction.

In the illustrated embodiment, the stator 510 is arranged to surround the rotor 520 radially outside the rotor 520. That is, the stator 510 is formed in a cylindrical shape in which a hollow portion for partially accommodating the cylindrical rotor 520 is formed.

An outer surface of the stator 510 may be in contact with an inner surface of the motor room 110. In other words, the stator 510 may be fixed to the motor room 110.

The rotor 520 is rotated by the magnetic field formed by the stator 510. That is, when the magnetic field is formed by the stator 510, the plurality of magnets (not shown) provided in the rotor 520 receives the electromagnetic force and accordingly the rotor 520 is rotated.

The rotating shaft unit 400 is rotatably coupled to the rotor 520. In other words, the rotor 520 is coupled to the rotating shaft unit 400 so as to be rotated together with the rotating shaft unit 400.

With the above-described structure, the rotational force of the motor unit 500 can be transmitted to the orbiting scroll 610 coupled to the rotating shaft unit 400.

The compression unit 600 rotates in response to the rotation of the motor unit 500 so as to substantially play a role of compressing a refrigerant. The compression unit 600 is rotatably connected to the motor unit 500 by the rotating shaft unit 400. That is, the rotating shaft unit 400, the motor unit 500, and the compression unit 600 may be rotated together.

The compression unit 600 includes an orbiting scroll 610 and a fixed scroll 620.

The orbiting scroll 610 is rotated by the rotation of the motor unit 500. Specifically, the orbiting scroll 610 is rotatably connected to the eccentric portion 430 of the rotating shaft unit 400.

When the motor unit 500 is rotated, the eccentric portion 430 is rotated centering on a different central axis from that of the rotating shaft unit 400 and the motor unit 500. That is, the eccentric portion 430 is eccentrically rotated with respect to the central axis of the motor unit 500.

Accordingly, the orbiting scroll 610 rotatably coupled to the eccentric portion 430 is eccentrically rotated with respect to the central axis of the motor unit 500. As will be described later, the fixed scroll 620 is disposed so as to have the same central axis as that of the motor unit 500.

Thus, the orbiting scroll 610 is eccentrically rotated relative to the fixed scroll 620. Accordingly, the refrigerant can be compressed in a space between the orbiting wrap 614 of the orbiting scroll 610 and the fixed wrap 624 of the fixed scroll 620.

The orbiting scroll 610 may be accommodated in the main housing 100. Specifically, the orbiting scroll 610 may be located on one side of the motor unit 500, namely, a front side of the motor unit 500 in the illustrated embodiment, in the inner space of the main housing 100.

The orbiting scroll 610 includes an orbiting plate portion 612, an orbiting wrap 614, and a rotating shaft coupling portion 616.

The orbiting plate portion 612 forms one side of the orbiting scroll 610. In the illustrated embodiment, the orbiting plate portion 612 forms a rear side of the orbiting scroll 610.

One side surface of the orbiting plate portion 612, namely, a front surface thereof in the illustrated embodiment, may be in contact with a rear surface of the fixed scroll 620.

The orbiting wrap 614 is engaged with the fixed wrap 624 of the fixed scroll 620 to form a predetermined space. The orbiting wrap 614 may be eccentrically rotated with respect to the rotating shaft unit 400 in the engaged state with the fixed wrap 624. Accordingly, the refrigerant can be compressed in the space between the orbiting wrap 614 and the fixed wrap 624.

The orbiting wrap 614 protrudes from the orbiting plate portion 612. In the illustrated embodiment, the orbiting wrap 614 protrudes from the front surface of the orbiting plate portion 612.

In the illustrated embodiment, the orbiting wrap 614 is formed in a spiral shape, but may be formed in any shape that can be engaged with the fixed wrap 624 and eccentrically rotated relative to the fixed wrap 624.

The rotating shaft coupling portion 616 is a portion to which the rotating shaft unit 400 is coupled. Specifically, the eccentric portion 430 of the rotating shaft unit 400 is coupled through the rotating shaft coupling portion 616.

The rotating shaft coupling portion 616 is formed through the rotating plate portion 612. In the illustrated embodiment, the rotating shaft coupling portion 616 is formed through the orbiting scroll 610 in the front-rear direction of the orbiting scroll 610.

The radius of the rotating shaft coupling portion 616 is preferably the same as or slightly greater than an outer diameter of the eccentric portion 430, so that the eccentric portion 430 is coupled therethrough.

The fixed scroll 620 is not rotated regardless of the rotation of the motor unit 500. Accordingly, when the motor unit 500 is rotated, the orbiting scroll 610 can be eccentrically rotated relative to the fixed scroll 620.

The fixed scroll 620 is located on one side of the main housing 100, namely, the front side of the main housing 420 opposite to the inverter unit 300 in the illustrated embodiment. An outer surface of the fixed scroll 620 may be exposed to the outside.

One surface of the fixed scroll 620, namely, a rear surface in the illustrated embodiment, may be in contact with the front surface of the main housing 100. Also, a separate coupling member (not shown) may be provided to couple the fixed scroll 620 and the main housing 100.

One surface of the fixed scroll 620, namely, a front surface in the illustrated embodiment, is coupled to the rear housing 200 with forming a predetermined space together with the rear housing 200.

The discharge chamber S3 is defined by an upper side of the space as described above.

As will be described later, a compression guide part 810 is provided on one surface of the fixed scroll 620 facing the rear housing 200. The compression guide part 810 is engaged with an exhaust guide part 820 provided in the rear housing 200 so that oil can be effectively separated from the mixed fluid. A detailed description thereof will be given later.

The fixed scroll 620 is rotatably coupled to the orbiting scroll 610. As described above, the fixed scroll 620 is fixed and the orbiting scroll 610 is rotated relative to the fixed scroll 620.

The fixed scroll 620 includes a fixed plate portion 622, a fixed wrap 624, a discharge valve 626, and a discharge port 628.

Also, the fixed scroll 620 is provided with a rotating shaft coupling portion (not shown) to which the sub bearing portion 440 of the rotating shaft unit 400 is rotatably coupled.

However, as described above, the fixed scroll 620 is not rotated, regardless of the rotation of the motor unit 500. Accordingly, it can be said that the rotating shaft coupling portion (not shown) of the fixed scroll 620 supports the rotating shaft unit 400.

The fixed plate portion 622 forms one side of the fixed scroll 620. In the illustrated embodiment, the fixed plate portion 622 forms the rear side of the fixed scroll 620.

One surface of the fixed plate portion 622, namely, a front surface thereof in the illustrated embodiment, may be in contact with a front surface of the orbiting scroll 610.

In the illustrated embodiment, a plurality of grooves is formed on an outer circumferential surface of the fixed plate portion 622. This is for weight reduction of the electric compressor 10, and its shape and number may be varied.

The fixed wrap 624 is coupled to the orbiting wrap 614 of the orbiting scroll 610 with forming a predetermined space. When the orbiting scroll 610 is rotated in response to the rotation of the motor unit 500 after the fixed wrap 624 is engaged with the orbiting wrap 614, the refrigerant may be compressed in a space between the fixed wrap 624 and the orbiting wrap 614.

The fixed wrap 624 protrudes from the fixed plate portion 622. In the illustrated embodiment, the fixed wrap 624 protrudes rearward from the fixed plate portion 622.

In the illustrated embodiment, the fixed wrap 624 may be formed in a spiral shape, but may be formed in any shape that can be engaged with the orbiting wrap 624 so that the orbiting wrap 614 is eccentrically rotated relative to the fixed wrap 624.

The discharge valve 626 is configured to open or close the discharge port 628 which is a passage through which the refrigerant compressed by the relative rotation of the orbiting scroll 610 and the fixed scroll 620 flows into the discharge chamber S3.

In one embodiment, the discharge valve 626 may be configured as a check valve, such as a reed valve, which restricts the flow of the fluid to a single direction in which the valve is opened and closed according to pressure.

The discharge valve 626 is located on one side of the fixed plate portion 622 opposite to the fixed wrap 624, namely, the front side of the fixed plate portion 622 in the illustrated embodiment. The discharge valve 626 is also configured to cover the discharge port 628.

When pressure of the compressed refrigerant becomes equal to or higher than predetermined pressure, the discharge valve 626 opens the discharge port 628. Accordingly, the compressed refrigerant can be introduced into the discharge chamber S3.

When the pressure of the compressed refrigerant is lower than the predetermined pressure, the discharge valve 626 closes the discharge port 628. This prevents the refrigerant with insufficient pressure (the lower pressure) from flowing into the discharge chamber S3.

The discharge port 628 is a passage through which the refrigerant compressed by the orbiting scroll 610 and the fixed scroll 620 flows into the discharge chamber S3. The discharge port 628 connects the discharge chamber S3 with the space formed between the orbiting wrap 614 and the fixed wrap 624, so that the fluid can flow.

The discharge port 628 is configured to be opened or closed. Specifically, the discharge valve 626 is provided on the discharge port 628, so as to open or close the discharge port 628 according to pressure of the compressed refrigerant.

The refrigerant discharged through the discharge port 628 flows into the oil separating member 800 via the discharge chamber S3 without being directly introduced into the oil separating member 800, which may result in reducing discharge resistance applied to the refrigerant. Accordingly, the pressure drop of the compressed refrigerant can be minimized.

As will be described later, the discharge port 628 may be provided with a discharge mesh member 831 of a mesh portion 830. The discharge mesh member 831 is configured to separate oil from a mixed fluid using a particle size.

The discharge mesh member 831 may also be formed to cover the discharge port 628 and the discharge valve 626 provided on the discharge port 628. A detailed description thereof will be given later.

The passage unit 700 is a path through which refrigerant and oil flow. The passage unit 700 is formed over the main housing 100 and the rear housing 200.

In an embodiment not shown, the passage unit 700 may also be formed in the inverter unit 300. In this case, the refrigerant can directly cool various inverter devices (not shown) constituting the inverter unit 300 as described above.

The passage unit 700 includes a refrigerant passage portion 710 and an oil passage portion 720.

The refrigerant passage portion 710 is a passage through which the refrigerant flows. The refrigerant passage portion 710 is defined by a space formed in the main housing 100. Alternatively, the refrigerant passage portion 710 may be formed by a separate refrigerant passage forming member (not shown).

The refrigerant passage portion 710 includes a first refrigerant passage 712 and a second refrigerant passage 714.

The first refrigerant passage 712 communicates with the motor room 110 and the second refrigerant passage 714. The refrigerant introduced into the motor room 110 of the main housing 100 through the intake port 120 flows to the second refrigerant passage 714 through the first refrigerant passage 712.

In the illustrated embodiment, the first refrigerant passage 712 is located in a lower space inside the main housing 100. The first refrigerant passage 712 may be located at an arbitrary position at which it can communicate the motor room 110 and the second refrigerant passage 714 with each other.

The second refrigerant passage 714 communicates the first refrigerant passage 712 and the compression unit 600 with each other. Specifically, the refrigerant that has passed through the first refrigerant passage 712 flows into the second refrigerant passage 714.

The refrigerant introduced into the second refrigerant passage 714 is moved into the space formed between the orbiting scroll 610 and the fixed scroll 620, thereby being compressed to have predetermined pressure. The compressed refrigerant then flows into the discharge chamber S3 through the discharge port 628 of the fixed scroll 620.

The refrigerant passage portion 710 may be provided with a refrigerant guide member (not shown) configured to restrict a flowing direction of the refrigerant that flows in the refrigerant passage portion 710.

The oil passage portion 720 is a passage through which oil flows. The oil passage portion 720 is defined by the space formed in the main housing 100 and the rear housing 200. Alternatively, the oil passage portion 720 may be formed by a separate oil passage forming member (not shown).

The oil passage portion 720 includes a first oil passage 722, a second oil passage 724, and a third oil passage 726.

The first oil passage 722 communicates the oil chamber (not shown) formed in the inner space of the electric compressor 10 with the oil supply guide passage 450. Oil separated from the refrigerant in the discharge chamber S3 is discharged to the oil exhaust passage 230 and collected in the oil chamber (not shown).

The oil collected in the oil chamber (not shown) then flows to the oil supply guide passage 450 of the rotating shaft unit 400 through the first oil passage 722. The first oil passage 722 may be provided with a power device (not shown) for providing transfer force to the oil so that the oil can be smoothly moved.

The second oil passage 724 communicates the oil supply guide passage 450 with the space between the eccentric portion 430 and the rotating shaft coupling portion 616.

The oil introduced through the second oil passage 724 is supplied to the space between the eccentric portion 430 and the rotating shaft coupling portion 616 of the orbiting scroll 610. In other words, the oil introduced through the second oil passage 724 flows into the space between an outer circumferential surface of the eccentric portion 430 and the rotating shaft coupling portion 616.

As a result, friction caused by the rotation of the orbiting scroll 610 may be mitigated, and thus the refrigerant can be efficiently compressed.

The third oil passage 726 communicates the oil supply guide passage 450 with a space between the sub bearing portion 440 and the rotating shaft coupling portion (not shown) of the fixed scroll 620.

The oil introduced through the third oil passage 726 is supplied to the space between the sub bearing portion 440 and the rotating shaft coupling portion (not shown) of the fixed scroll 620. In other words, the oil introduced through the third oil passage 726 flows into the space between an outer circumferential surface of the sub bearing portion 440 and the rotating shaft coupling portion (not shown) of the fixed scroll 620.

As a result, the friction caused by the rotation of the rotating shaft unit 400 may be mitigated, and thus the refrigerant can be efficiently compressed.

The oil introduced into the compression unit 600 may be mixed with the refrigerant introduced into the compression unit 600 through the refrigerant passage portion 710. The mixed fluid of the compressed refrigerant and the oil then flows into the discharge chamber S3, and a primary process of separating the oil from the refrigerant is carried out.

The electric compressor 10 according to the embodiment of the present disclosure further includes an oil separating member 800 for effectively separating oil from a mixed fluid of refrigerant compressed in the compression unit 600 and the oil.

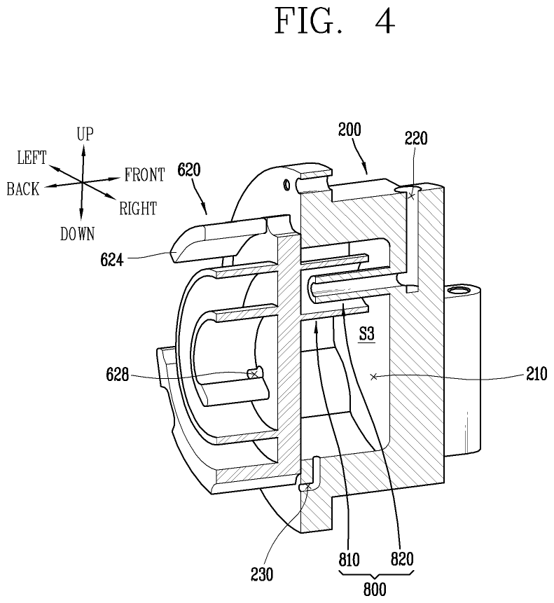

Hereinafter, the oil separating member 800 included in the electric compressor 10 according to the embodiment of the present disclosure will be described in detail with reference to FIGS. 4 to 14.

Referring to FIG. 4, the oil separating member 800 according to the illustrated embodiment includes a compression guide part 810 and an exhaust guide part 820.

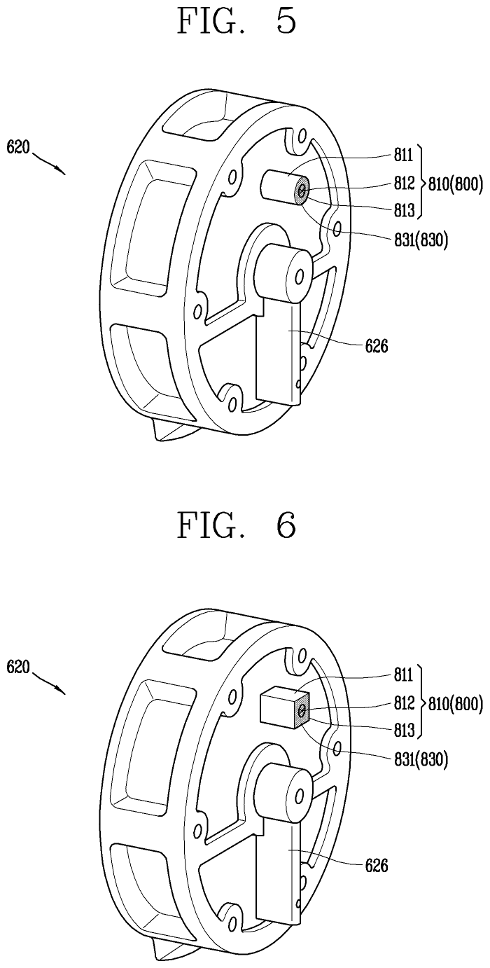

Referring to FIGS. 5 to 7, the compression guide part 810 protrudes from one surface of the fixed scroll 620.

Specifically, the compression guide part 810 protrudes from one surface of the fixed scroll 620, which faces the rear housing 200, toward the rear housing 200.

The compression guide part 810 forms an exhaust passage, along which a mixed fluid flows toward the exhaust port 220, together with the exhaust guide part 820 to be described later. Specifically, the exhaust guide part 820 is inserted into the compression guide part 810 to form the exhaust passage.

The compression guide part 810 may be integrally formed with the fixed scroll 620. Alternatively, the compression guide part 810 may be formed separately from the fixed scroll 620 and may be coupled to the fixed scroll 620 by a coupling member (not shown) or in a welding manner.

The compression guide part 810 is located higher than the discharge port 628 formed in the fixed scroll 620. Accordingly, the mixed fluid, which is reduced in density due to the oil being separated therefrom after it is introduced into the discharge chamber S3 through the discharge port 628, flows upward and enters the exhaust passage.

The compression guide part 810 includes a compression outer circumferential surface 811, a compression hollow portion 812, and a compression end portion 813.

The compression outer circumferential surface 811 forms an outer surface of the compression guide part 810. The compression outer circumferential surface 811 forms the outermost portion of the oil separating member 800.

That is, when the mixed fluid introduced into the discharge chamber S3 flows along the exhaust passage, the mixed fluid may first collide with the compression outer circumferential surface 811.

The compression hollow portion 812 is a space formed in the compression guide part 810. The compression hollow portion 812 may be formed through the compression guide part 810 in a lengthwise direction of the compression guide part 810. In the illustrated embodiment, the compression hollow portion 812 is formed through the compression guide part 810 in the front-rear direction.

An exhaust guide part 820 which will be described later is inserted into the compression hollow portion 812. At this time, an inner circumferential surface of the compression guide part 810 forming the compression hollow portion 812 and an outer circumferential surface of the exhaust guide part 820 are spaced apart from each other by a predetermined distance.

An exhaust passage may be formed between the compression hollow portion 812 and the exhaust guide part 820 by virtue of the predetermined distance.

In the illustrated embodiment, the compression hollow portion 812 is formed in a cylindrical shape. The compression hollow portion 812 may be formed in any shape into which the exhaust guide part 820 can be inserted.

However, since the exhaust guide part 820 must be inserted into the compression hollow portion 812, the compression hollow portion 812 preferably has a sufficiently large cross section so as to be spaced apart from the outer circumferential surface of the inserted exhaust guide part 820 by the predetermined distance.

The compression end portion 813 is a portion of the compression guide part 810, which is closest to the rear housing 200. That is, in the illustrated embodiment, the compression end portion 813 is a front end portion of the compression guide part 810.

The compression end portion 813 may be provided with a compression flange 851 of a flange portion 850 to be described later. The compression flange 851 is configured to increase a surface area of the compression guide part 810. Accordingly, collision between the compression guide part 810 and the mixed fluid can be caused more actively. A detailed description thereof will be given later.

In the embodiment illustrated in FIG. 5, the compression guide part 810 is formed in a cylindrical shape having a circular cross section.

Also, in the embodiment illustrated in FIG. 6, the compression guide part 810 is formed in a shape of a quadrangular column having a rectangular cross section.

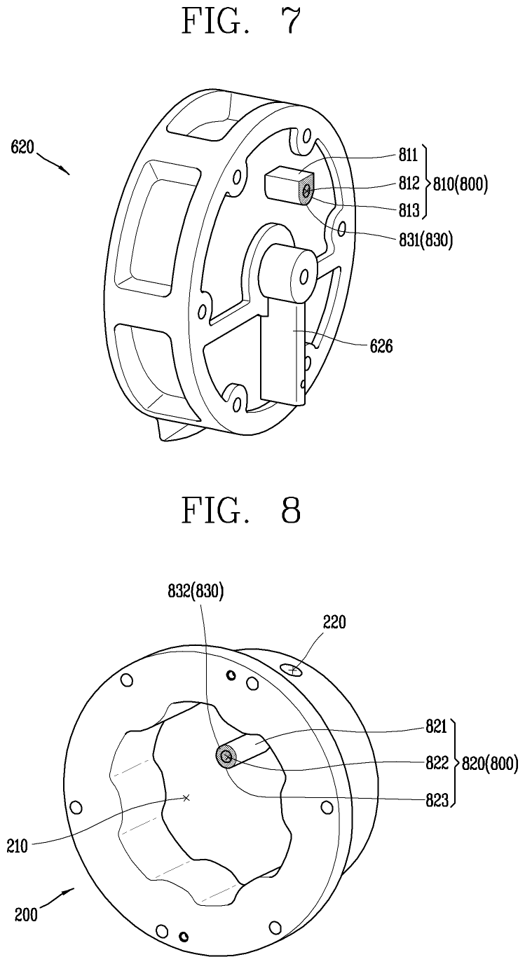

Further, in the embodiment illustrated in FIG. 7, the compression guide part 810 is formed in a shape of a column having a cross section with one curved surface.

The compression guide part 810 may be formed in an arbitrary shape that can increase a protruded portion inside the discharge chamber S3 so as to increase the frequency of collision with the mixed fluid. That is, the compression guide part 810 may be formed in a shape of a cylinder, an elliptical column, a polygonal column, an arbitrary solid column having at least one curved surface, or the like.

The protruded degree of the compression guide part 810 may be determined based on a protruded degree of the exhaust guide part 820 to be explained later and a distance between the fixed scroll 620 and the rear housing 200.

That is, the maximum protruded length of the compression guide part 810 may be determined as the maximum length at which the compression end portion 813 is not in contact with one surface of the rear housing 200 facing the fixed scroll 620.

The minimum protruded length of the compression guide part 810 may be determined as the minimum length at which an exhaust end portion 823 of the exhaust guide part 820 to be described later can be at least partially accommodated in the compression hollow portion 812.

Referring to FIGS. 8 to 10, the exhaust guide part 820 protrudes from one surface of the rear housing 200.

Specifically, the exhaust guide part 820 protrudes from one surface of the space portion 210, which faces the fixed scroll 620, toward the fixed scroll 620.

The exhaust guide part 820 forms an exhaust passage, along which a mixed fluid flows toward the exhaust port 220, together with the compression guide part 810. Specifically, the exhaust guide part 820 is inserted into the compression hollow portion 812 to form the exhaust passage.

The exhaust guide part 820 may be formed integrally with the rear housing 200. Alternatively, the exhaust guide part 820 may be formed separately from the rear housing 200 and may be coupled to the rear housing 200 by a coupling member (not shown) or in a welding manner.

The exhaust guide part 820 may be located to correspond to a position of the compression guide part 810. That is, the position of the exhaust guide part 820 may be determined in a manner that the exhaust guide part 820 can be inserted into the compressed hollow portion 812 when the fixed scroll 620 and the rear housing 200 are coupled to each other.

As described above, the compression guide part 810 is located higher than the discharge port 628, and thus the exhaust guide part 820 is also preferably located higher than the discharge port 628.

The exhaust guide part 820 includes an exhaust outer circumferential surface 821, an exhaust hollow portion 822, and an exhaust end portion 823.

The exhaust outer circumferential surface 821 forms an outer surface of the exhaust guide part 820. When the exhaust guide part 820 is inserted into the compression hollow portion 812, the exhaust outer circumferential surface 821 is spaced apart from an inner circumferential surface of the compression guide part 810 forming the compression hollow portion 812 by a predetermined distance.

An exhaust passage may be formed between the compression hollow portion 812 and the exhaust guide part 820 by virtue of the predetermined distance.

The exhaust hollow portion 822 is a space formed in the exhaust guide part 820. The exhaust hollow portion 822 may be formed through the exhaust guide part 820 in a lengthwise direction of the exhaust guide part 820. In the illustrated embodiment, the exhaust hollow portion 822 is formed through the exhaust guide part 820 in the front-rear direction.

The exhaust hollow portion 822 forms a part of an exhaust passage. The exhaust hollow portion 822 also communicates with the exhaust port 220 of the rear housing 200.

Accordingly, the mixed fluid flowing into the discharge chamber S3 through the discharge port 628 of the fixed scroll 620 flows along the exhaust passage. While the mixed fluid flows along the exhaust passage, the oil may be separated from the fluid. The fluid may then be exhausted to the outside of the electric compressor 10 through the exhaust port 220.

The exhaust hollow portion 822 is preferably formed to have a cross-sectional area sufficient for the oil-separated mixed fluid to flow therein.

The exhaust end portion 823 is a portion of the exhaust guide part 820, which is closest to the fixed scroll 620. That is, in the illustrated embodiment, the exhaust end portion 823 is a rear end portion of the exhaust guide part 820.

The exhaust end portion 823 may be provided with an exhaust mesh member 832 of a mesh portion 830 to be described later. The exhaust mesh member 832 is configured to separate the oil from the mixed fluid using a particle size.

The exhaust end portion 823 may also be provided with an exhaust flange 852 of a flange portion 850 to be described later. The exhaust flange 852 is configured to increase a surface area of the exhaust guide part 820. As a result, collision between the exhaust guide part 820 and the mixed fluid can be made more actively.

Detailed description of the exhaust mesh member 832 and the exhaust flange 852 will be given later.

In the embodiment illustrated in FIG. 8, the exhaust guide part 820 is formed in a cylindrical shape having a circular cross section.

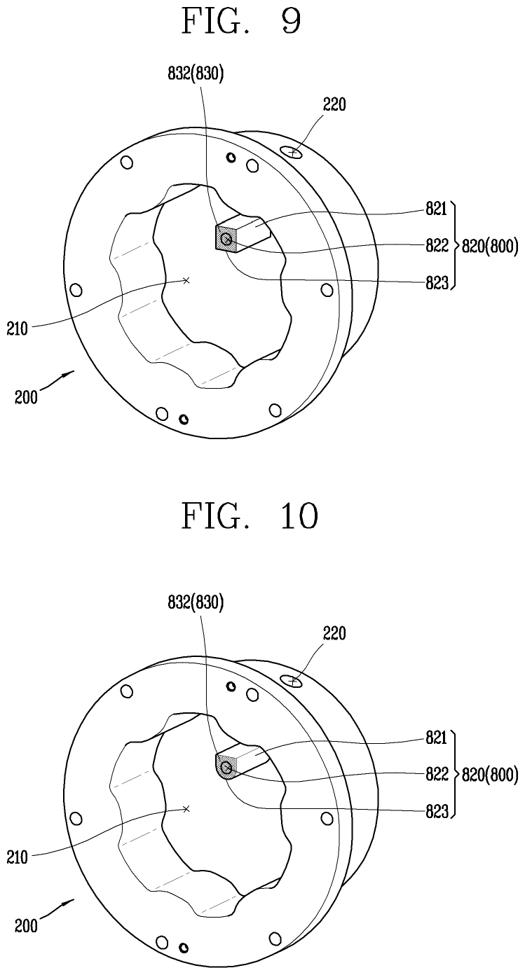

Also, in the embodiment illustrated in FIG. 9, the exhaust guide part 820 is formed in a shape of a quadrangular column having a rectangular cross section.

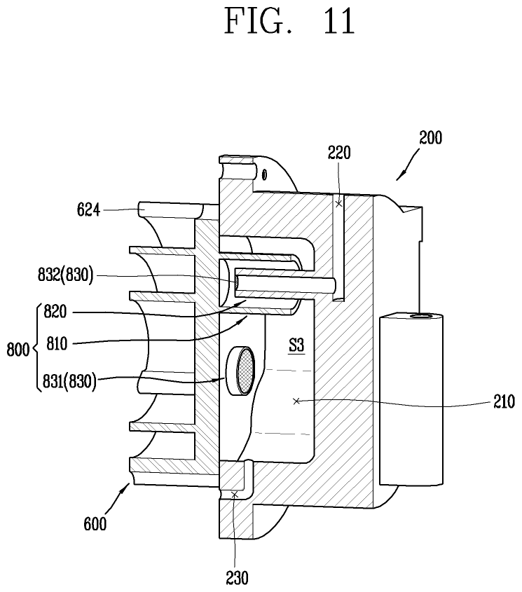

Further, in the embodiment illustrated in FIG. 10, the exhaust guide part 820 is formed in a shape of a column having a cross section with one curved surface.

The exhaust guide part 820 may be formed in an arbitrary shape which can increase a surface area between the exhaust guide part 820 and an inner circumferential surface of the compression guide part 810 in the compression hollow portion 812. That is, the exhaust guide part 820 may be formed in a shape of a cylinder, an elliptical column, a polygonal column, an arbitrary solid column having at least one curved surface, or the like.

However, considering that the exhaust guide part 820 is inserted into the compressed hollow portion 812, the shape of the exhaust guide part 820 is preferably determined to correspond to the shape of the compressed hollow portion 812.

The protruded degree of the exhaust guide part 820 may be determined based on a protruded degree of the compression guide part 810 and a distance between the fixed scroll 620 and the rear housing 200.

That is, the maximum protruded length of the exhaust guide part 820 may be determined as the maximum length at which the exhaust end portion 823 is not in contact with one surface of the fixed scroll 620 facing the rear housing 200.

The minimum protruded length of the exhaust guide part 820 may be determined as the minimum length at which the exhaust end portion 823 can be at least partially accommodated in the compression hollow portion 812. Referring to FIG. 11, the oil separating member 800 according to the illustrated embodiment includes a mesh portion 830.

The mesh portion 830 separates oil and refrigerant contained in a mixed fluid by using particle sizes.

That is, particles of oil in a liquid state are generally larger than particles in a gaseous state. Thus, the mesh portion 830 is configured to filter the particles of the oil while allowing the particles of the refrigerant to pass therethrough.

The mesh portion 830 may include a plurality of through holes (not shown). The size of the through hole (not shown) is preferably smaller than the particles of the oil but larger than the particles of the refrigerant. The through hole (not shown) may function as a filtering hole.

The mesh portion 830 includes a discharge mesh member 831 and an exhaust mesh member 832.

The discharge mesh member 831 separates the oil from the mixed fluid, which flows from the discharge port 628 of the fixed scroll 620 to the discharge chamber S3. The oil separated by the discharge mesh member 831 is moved downward, passes through the oil exhaust passage 230, and is collected in the oil chamber (not shown).

The discharge mesh member 831 is configured to cover the discharge port 628. Specifically, the discharge mesh member 831 covers the discharge port 628 and the discharge valve 626 which opens or closes the discharge port 628.

The discharge mesh member 831 may be located at a predetermined distance from one surface of the fixed scroll 620 (one surface facing the rear housing 300) so as to secure a movable distance of the discharge valve 626.

The exhaust mesh member 832 separates the oil from the mixed fluid, which flows into the exhaust hollow portion 822 in the exhaust passage. The oil separated by the exhaust mesh member 832 is moved downward and collected in the oil chamber (not shown) via the oil exhaust passage 230.

The exhaust mesh member 832 is provided at the exhaust end portion 823 of the exhaust guide part 820. Specifically, the exhaust mesh member 832 is located at the exhaust end portion 823 and is configured to cover the exhaust hollow portion 822 which faces the exhaust end portion 823.

That is, the mixed fluid introduced into the exhaust hollow portion 822 necessarily passes through the exhaust mesh member 832.

The oil of the mixed fluid can be separated not only by the collision in the discharge chamber S3 but also by the filtering effect of the mesh portion 830. Therefore, the oil separation efficiency can be improved by the mesh portion 830.

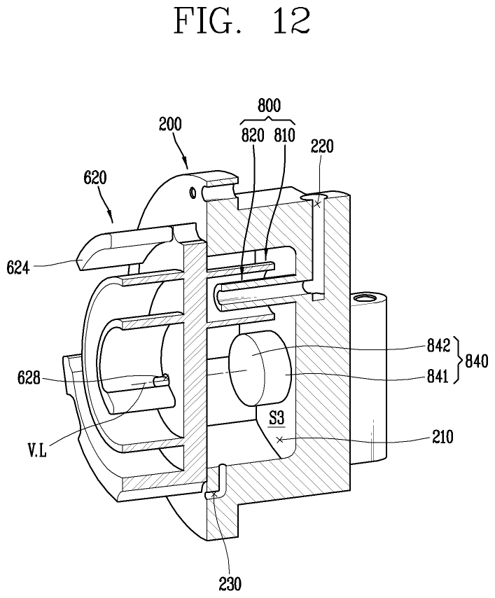

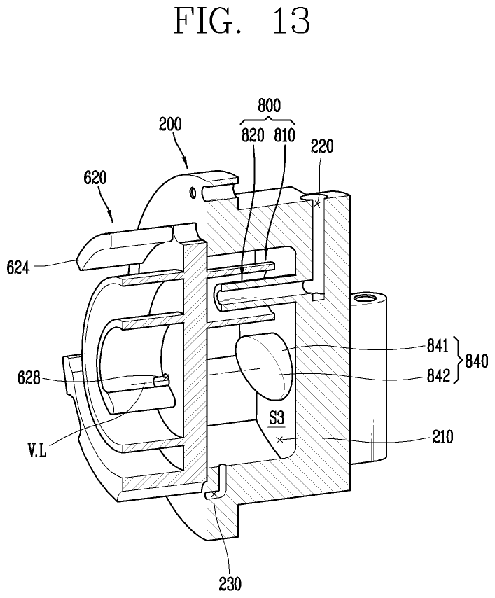

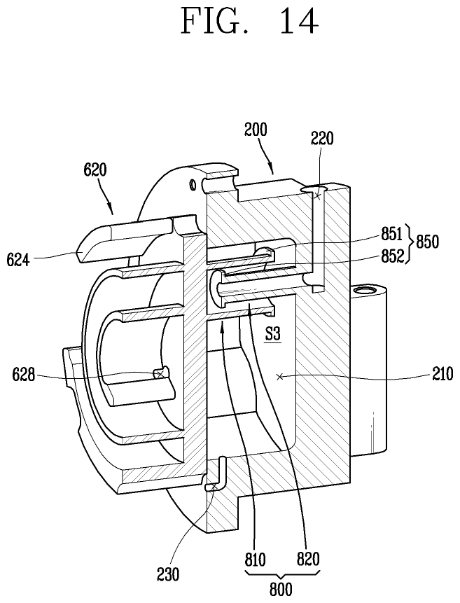

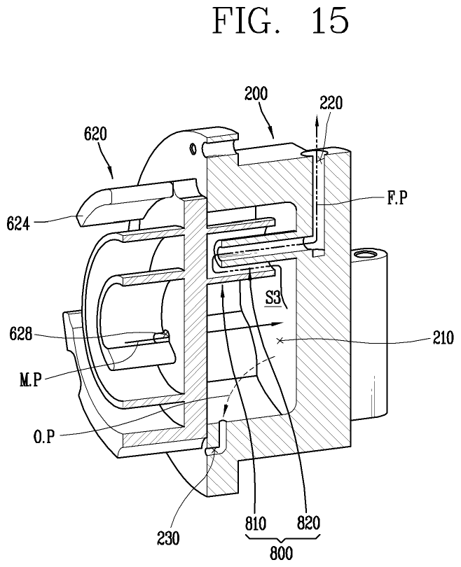

Referring to FIGS. 12 and 13, the oil separating member 800 according to the illustrated embodiment includes a separation protruding portion 840.

The separation protruding portion 840 protrudes toward the fixed scroll 620 from one surface of the rear housing 200 defining the discharge chamber S3, namely, one surface of the rear housing 200 facing the fixed scroll 620.

The separation protruding portion 840 is configured to increase a surface area of an inner wall of the discharge chamber S3 with which the mixed fluid collides. Therefore, the frequency of collision between the mixed fluid and the inner wall of the discharge chamber S3 is increased, and thus the oil separation efficiency can be improved.

Further, the separation protruding portion 840 is configured to reduce a distance by which the mixed fluid discharged from the discharge port 628 must move until colliding with the inner wall of the discharge chamber S3. Therefore, since the mixed fluid collides with the inner wall of the discharge chamber S3 more quickly, the oil separation efficiency can be improved.

In the illustrated embodiment, the separation protruding portion 840 may be formed in a cylindrical shape with a circular cross section, but its shape may be varied.

In one embodiment, the separation protruding portion 840 may be located on a virtual line VL extending from the discharge port 628. That is, the position of the separation protruding portion 840 may be configured to collide with the separation protruding portion 840 when the mixed fluid discharged from the discharge port 628 is linearly moved along the discharge port 628.

The separation protruding portion 840 includes a protrusion outer circumferential surface 841 and a protrusion end surface 842.

The protrusion outer circumferential surface 841 forms a side surface of the separation protruding portion 840. The protrusion outer circumferential surface 841 is located between the inner wall of the discharge chamber S3 and the protrusion end surface 842.

The protrusion end surface 842 is one surface of the separation protruding portion 840 facing the fixed scroll 620. In other words, the protrusion end surface 842 is a portion of the separation protruding portion 840 which is the closest to the fixed scroll 620.

In the illustrated embodiment, the separation protruding portion 840 is formed in a shape of a column, and thus the protrusion end surface 842 may also be defined as an upper surface.

The protrusion end surface 842 may be formed at various angles.

That is, in the embodiment illustrated in FIG. 12, the protrusion end surface 842 is formed perpendicular to the protrusion outer circumferential surface 841. That is, the protrusion end surface 842 is formed parallel to the inner wall of the discharge chamber S3. In this embodiment, a movement path of the mixed fluid discharged from the discharge port 628 can be minimized.

In the embodiment illustrated in FIG. 13, the protrusion end surface 842 is inclined downward so as to form a predetermined angle with the inner wall of the discharge chamber S3. That is, a distance between the inner wall of the discharge chamber S3 and an upper side of the protrusion end surface 842 is longer than a distance between the inner wall of the discharge chamber S3 and a lower side of the protrusion end surface 842. In this embodiment, the oil separated from the mixed fluid can be more effectively moved downward.

That is, the angle formed by the protrusion end surface 842 and the inner wall of the discharge chamber S3 may be changed to an arbitrary angle that can improve the oil separation efficiency.

As the separation protruding portion 840 is formed, the frequency and effect of collision between the mixed fluid and the inner wall of the discharge chamber S3 can be increased, thereby improving the oil separation efficiency.

Referring to FIG. 14, the oil separating member 800 according to the illustrated embodiment includes a flange portion 850.

The flange portion 850 is provided on the compression guide part 810 or the exhaust guide part 820, to increase a surface area of the compression guide part 810 or the exhaust guide part 820.

Further, the flange portion 850 serves as a kind of obstacle, and is configured to make the exhaust passage more complicated.

As a result, possibility of collision between the mixed fluid and the exhaust passage is improved while the mixed fluid flows toward the exhaust port 220. Further, since the exhaust passage extends, possibility of oil separation due to the own weight of the oil is increased, and the oil separation efficiency can thus be improved.

The flange portion 850 includes a compression flange 851 and an exhaust flange 852.

The compression flange 851 is provided on the compression guide part 810. Specifically, the compression flange 851 protrudes from the compression outer circumferential surface 811 of the compression guide part 810. In one embodiment, the compression flange 851 may be located on the compression end portion 813.

In the illustrated embodiment, the compression flange 851 protrudes from the compression outer circumferential surface 811 of the compression guide part 810 along a circumferential direction. The shape of the compression flange 851 may be changed to correspond to the shape of the compression guide part 810. Alternatively, the compression flange 851 may not be continuously formed along the circumferential direction of the compression outer circumferential surface 811, but may be provided with a plurality of protrusions which are spaced apart from one another with predetermined distances.

The compression flange 851 may be formed in an arbitrary shape which can increase a surface area of the compression outer circumferential surface 811 and diversify the exhaust passage.

The compression flange 851 forms a part of the exhaust passage of the mixed fluid, which flows from the discharge chamber S3 toward the exhaust port 220. In other words, the exhaust passage may be made more complicated by the compression flange 851.

Accordingly, the oil separation effect can be improved not only by the collision but also by the own weight of the oil due to the extended exhaust passage, while the mixed fluid flows toward the exhaust port 220. This may result in enhancement of the oil separation efficiency from the mixed fluid.

The compression flange 851 may be integrally formed with the compression guide part 810 or may be separately formed to be coupled to the compression guide part 810. In this case, the compression flange 851 may be coupled to the compression guide part 810 in a screwing, inserting or welding manner.

The exhaust flange 852 is provided on the exhaust guide part 820. Specifically, the exhaust flange 852 protrudes from the exhaust outer circumferential surface 821 of the exhaust guide part 820. In one embodiment, the exhaust flange 852 may be located on the exhaust end portion 823.

In the illustrated embodiment, the exhaust flange 852 protrudes from the exhaust outer circumferential surface 821 of the exhaust guide part 820 along a circumferential direction. The shape of the exhaust flange 852 may be changed to correspond to the shape of the exhaust guide part 820.

Alternatively, the exhaust flange 852 may not be continuously formed along the circumferential direction of the exhaust outer circumferential surface 821, but may be provided with a plurality of protrusions which are spaced apart from one another with predetermined distances.

The exhaust flange 852 may be formed in an arbitrary shape which can increase a surface area of the exhaust outer circumferential surface 821 and diversify the exhaust passage.

The exhaust flange 852 forms a part of the exhaust passage of the mixed fluid, which flows from the discharge chamber S3 toward the exhaust port 220. In other words, the exhaust passage may be made more complicated by the exhaust flange 852.

Accordingly, the oil separation effect can be improved not only by the collision while the mixed fluid flows toward the exhaust port 220, but also by the own weight of the oil due to the extended exhaust passage. This may result in enhancement of the oil separation efficiency from the mixed fluid.

The electric compressor 10 according to the embodiment of the present disclosure may include at least one of the compression guide part 810, the exhaust guide part 820, the mesh portion 830, the separation protruding portion 840, and the flange portion 850 which are included in the oil separating member 800.

In other words, the electric compressor 10 according to the present disclosure may include all or at least one of those components. Accordingly, various configurations can be derived depending on combination of the respective components of the oil separating member 800.

The oil separating member 800 according to the embodiment of the present disclosure may be provided in the electric compressor 10 to effectively separate oil from a mixed fluid of compressed refrigerant and oil.

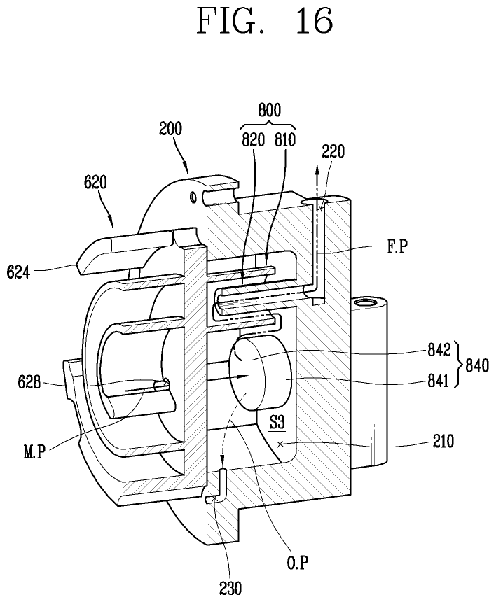

Hereinafter, the process of separating the oil from the mixed fluid by the oil separating member 800 according to the embodiment of the present disclosure will be described in detail with reference to FIGS. 15 to 20. In the following description, the discharge valve 626 is omitted from the description and illustration to facilitate understanding.

In the following description, a mixed fluid from which oil has primarily been separated due to the collision with the inner wall of the discharge chamber S3 or the separation protruding portion 840 is referred to “refrigerant”.

Referring to FIG. 15, the oil separating member 800 according to the illustrated embodiment includes the compression guide part 810 and the exhaust guide part 820.

First, the mixed fluid compressed in the compression unit 600 is introduced into the discharge chamber S3 through the discharge port 628 of the fixed scroll 620.

The mixed fluid introduced into the discharge chamber S3 collides with the inner wall of the discharge chamber S3. Accordingly, the oil is separated from the mixed fluid. The separated oil drops downward and is discharged from the discharge chamber S3 through the oil exhaust passage 230.

In the mixed fluid from which the oil has been separated, a composition ratio of the refrigerant is increased and density is decreased. Accordingly, the fluid flows upward.

At this time, the compression outer circumferential surface 811 of the compression guide part 810 partially blocks the path of the refrigerant. Accordingly, the exhaust passage of the refrigerant starts from a narrow space between the compression end portion 813 and the inner wall of the discharge chamber S3.

The refrigerant introduced in the space passes through the compression hollow portion 812. Since the exhaust guide part 820 is inserted into the compression hollow portion 812, the exhaust passage is formed between the exhaust outer circumferential surface 821 and the inner circumferential surface of the compression guide part 810.

The refrigerant which has reached the exhaust end portion 823 is turned to be introduced into the exhaust hollow portion 822. The exhaust hollow portion 822 communicates with the exhaust port 220. Accordingly, the refrigerant introduced in the exhaust hollow portion 822 can be exhausted to the outside of the electric compressor 10 through the exhaust port 220.

In this embodiment, since the compression guide part 810 and the exhaust guide part 820 are provided, the exhaust passage of the refrigerant starts from the inner wall of the front side of the discharge chamber S3, extends to the inner wall of the rear side of the discharge chamber S3 and then is connected to the exhaust port 220 formed in the inner wall of the front side of the discharge chamber S3.

That is, the exhaust passage of the refrigerant is not formed linearly but formed in a shape that the fluid can come and go in the discharge chamber S3 in the front-rear direction. Thus, the length of the exhaust passage can be increased.

Further, the exhaust passage is formed between the compression guide part 810 and the exhaust guide part 820. Therefore, the refrigerant collides with the compression guide part 810 and the exhaust guide part 820 while flowing through the exhaust passage, so that the oil remaining in the refrigerant can be further separated.

This may result in improving the oil separation efficiency by which the oil is separated from the mixed fluid.

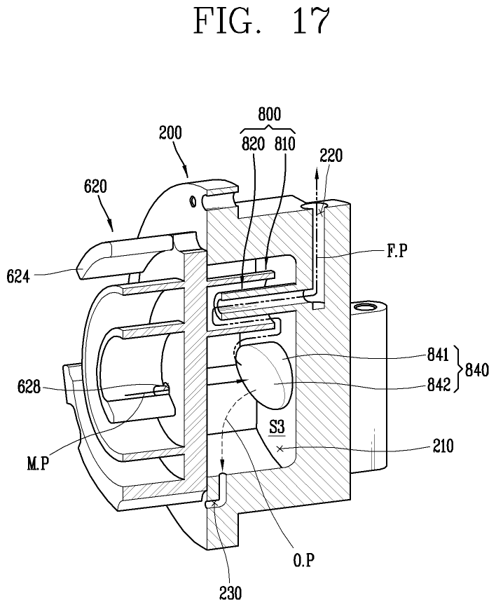

Referring to FIGS. 16 and 17, the oil separating member 800 according to the illustrated embodiment includes the exhaust guide part 820 and the separation protruding portion 840.

The process of forming the exhaust passage according to the compression guide part 810 and the exhaust guide part 820 and the oil separation process are the same as those described in the case (1). Therefore, the separation process by the separation protruding portion 840 will be mainly described hereinafter.

First, the mixed fluid compressed in the compression unit 600 is introduced into the discharge chamber S3 through the discharge port 628 of the fixed scroll 620.

The mixed fluid introduced into the discharge chamber S3 flows toward the inner wall of the discharge chamber S3. At this time, since the separation protruding portion 840 protrudes from the inner wall of the front side of the discharge chamber S3, the mixed fluid collides with the separation protruding portion 840.

As described above, the separation protruding portion 840 may be located on a virtual line VL extending from the discharge port 628. Therefore, the mixed fluid discharged by high pressure can be moved in a straight line and collide with the separation protruding portion 840.

At this time, a distance by which the mixed fluid is moved to collide with the separation protruding portion 840 is shorter than a distance by which the mixed fluid is moved to collide with the inner wall of the discharge chamber S3. Therefore, a time required until an initial collision of the mixed fluid is reduced.

Further, after the mixed fluid collides with the separation protruding portion 840, the mixed fluid moves along the protrusion outer circumferential surface 841 of the separation protruding portion 840, so that further collision with the inner wall of the front side of the discharge chamber S3 can occur or be expected.

By the collision(s), the oil is separated from the mixed fluid. The separated oil drops downward and is discharged to the outside of the discharge chamber S3 through the oil exhaust passage 230. Also, the refrigerant from which the oil has been separated flows along the exhaust passage described in the case (1), and then exhausted to the outside of the electric compressor 10 through the exhaust port 220.

In this embodiment, the exhaust passage can be diversified by the compression guide part 810 and the exhaust guide part 820 and also an initial collision time point between the mixed fluid and the discharge chamber S3 can get earlier by the formation of the separation protruding portion 830.

Therefore, the oil can be separated more quickly from the mixed fluid, and further collision with the inner wall of the discharge chamber S3 can be expected even after the collision with the separation protruding portion 840, which may result in improving the oil separation efficiency.

In addition, in the case of the embodiment illustrated in FIG. 17, the protrusion end surface 842 of the separation protruding portion 840 is formed to be inclined downward. This structure can guide the oil separated from the mixed fluid to flow downward.

Further, since the mixed fluid which has collided with the protrusion end surface 842 is partially moved toward the fixed scroll 620 along the protrusion end surface 842 and moves upward, which may result in extending the movement path of the refrigerant.

As a result, the frequency of collision between the oil and the inner wall of the discharge chamber S3 and the oil separation effect by the own weight of the oil can be increased, thereby improving the oil separation efficiency.

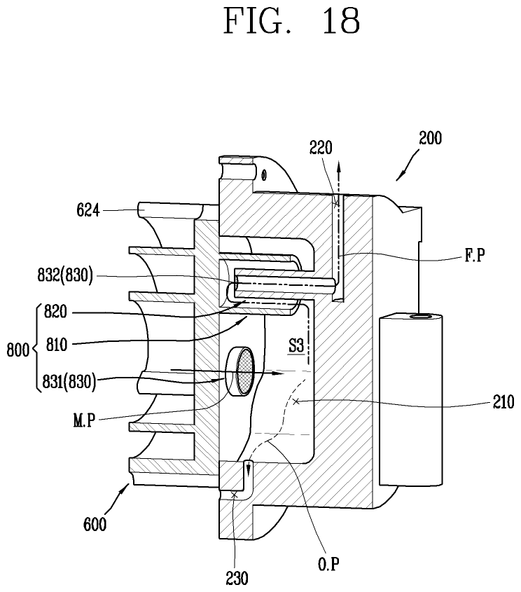

Referring to FIG. 18, the oil separating member 800 according to the illustrated embodiment includes the compression guide part 820, the exhaust guide part 820 and the mesh portion 830.

The process of forming the exhaust passage according to the compression guide part 810 and the exhaust guide part 820 and the oil separation process are the same as those described in the case (1). Therefore, the separation process by the mesh portion 830 will be mainly described hereinafter.

First, the mixed fluid compressed in the compression unit 600 is introduced into the discharge chamber S3 through the discharge port 628 of the fixed scroll 620. At this time, the discharge port 628 is provided with the discharge mesh member 831 which covers the discharge port 628.

As aforementioned, the discharge mesh member 831 is formed to be larger than the discharge port 628 so as to cover both the discharge port 628 and the discharge valve 626.

The discharge mesh member 831 includes a plurality of openings. Each of the openings is formed to be smaller than the size of oil particles, and larger than the size of refrigerant particles.

Therefore, when the mixed fluid passes through the discharge mesh member 831, the oil particles cannot pass through the discharge mesh member 831 but the refrigerant particles can pass through the discharge mesh member 831. Thus, the oil can be separated from the mixed fluid.

The refrigerant from which the oil has been separated by the discharge mesh member 831 collides with the inner wall of the discharge chamber S3. Accordingly, the oil particles that may remain in the refrigerant can be effectively separated.

The refrigerant from which the oil has been separated flows along the exhaust passage described in the case (1), and then exhausted to the outside of the electric compressor 10 through the exhaust port 220.

At this time, the exhaust end portion 823 may be provided with the exhaust mesh member 832.

The refrigerant that has passed through the compression hollow portion 812 and reached the exhaust end portion 823 is separated from the residual oil by the exhaust mesh member 832 in the course of flowing into the exhaust hollow portion 822. The refrigerant having passed through the exhaust hollow portion 822 is exhausted to the outside of the electric compressor 10 through the exhaust port 220.

Also, at least one of the discharge mesh member 831 and the exhaust mesh member 832 may be provided. That is, only one of the discharge mesh member 831 or the exhaust mesh member 832 may be provided, or both the discharge mesh member 831 and the exhaust mesh member 832 may be provided.

Of course, both the discharge mesh member 831 and the exhaust mesh member 832 may be preferably provided in order to improve the oil separation efficiency, but it may preferably be determined in consideration of the discharge and flow speeds of the mixed fluid and the refrigerant.

The plurality of openings formed in each of the discharge mesh member 831 and the exhaust mesh member 832 may have different sizes from each other.

That is, the discharge mesh member 831 is configured to primarily filter the mixed fluid. In addition, the exhaust mesh member 832 is configured to filter the oil remaining in the refrigerant from which the oil has been primarily separated.

Therefore, the size of the plurality of openings of the discharge mesh member 831 may be formed to be relatively larger than the size of the plurality of openings of the exhaust mesh member 832.

In this embodiment, the exhaust passage is diversified by the compression guide part 810 and the exhaust guide part 820, and also the mesh portion 830 is provided to filter the mixed fluid and the refrigerant while flowing.

Therefore, the oil can be separated not only by the collision and the own weight of the oil but also by filtration according to the particle size, which may result in improvement of the oil separation efficiency.

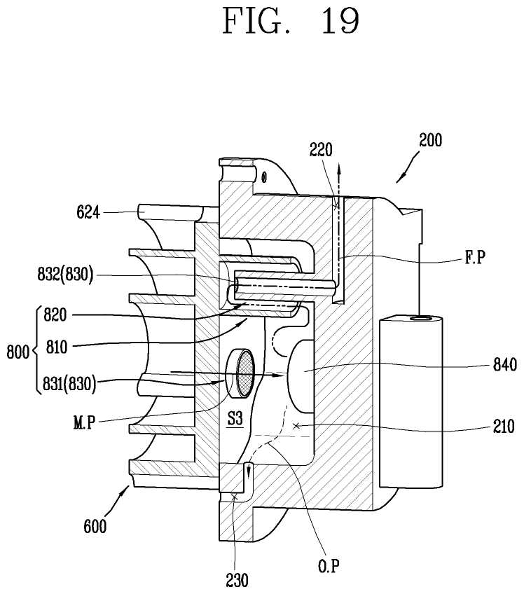

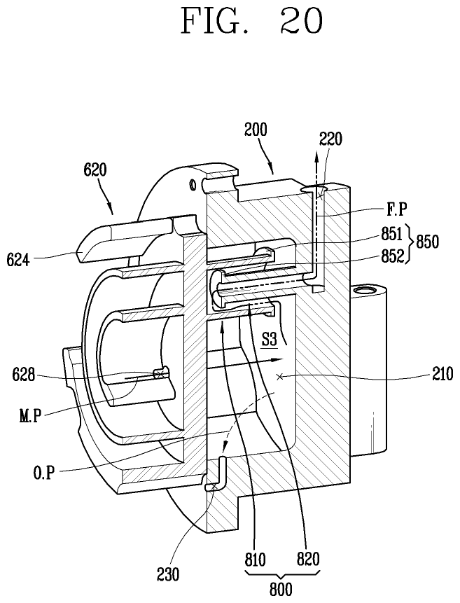

Referring to FIG. 19, the oil separating member 800 according to the illustrated embodiment includes the compression guide part 820, the exhaust guide part 820, and the flange portion 850.

The process of forming the exhaust passage according to the compression guide part 810 and the exhaust guide part 820 and the oil separation process are the same as those described in the case (1). Therefore, the separation process by the flange portion 850 will be mainly described hereinafter.

First, the mixed fluid compressed in the compression unit 600 is introduced into the discharge chamber S3 through the discharge port 628 of the fixed scroll 620.

At this time, the compression flange 851 is provided on the compression outer circumferential surface 811 of the compression guide part 810. Therefore, while the mixed fluid moves along the exhaust passage, further collision with the compression flange 851 occurs as well as the collision with the inner wall of the discharge chamber S3.

The refrigerant which has entered the exhaust passage proceeds toward the exhaust end portion 823. At this time, the exhaust flange 852 is provided on the exhaust outer circumferential surface 821. Thus, when the refrigerant moves toward the exhaust end portion 823, the additional collision with the exhaust flange 852 occurs.

The position, number and shape of the compression flange 851 and the exhaust flange 852 may be varied.

That is, the compression flange 851 may be provided in plurality, spaced apart from each other in a lengthwise direction of the compression guide part 810. The compression flange 851 may protrude toward the compression hollow portion 812 of the compression guide part 810.

Similarly, the exhaust flange 852 may be provided in plurality, spaced apart from each other in a lengthwise direction of the exhaust guide part 820. Further, the exhaust flange 852 may protrude toward the exhaust hollow portion 822 of the exhaust guide part 820.

In this embodiment, since the frequency of collision of the mixed fluid and the refrigerant is increased by the flange portion 850, the oil can be effectively separated from the mixed fluid and the refrigerant.

Also, since the compression flange 851 and the exhaust flange 852 are provided, the shape of the exhaust passage can be diversified. That is, the moving distance of the refrigerant flowing through the exhaust passage is increased. Thus, the oil separation effect by the own weight of the oil can also be improved.

Referring to FIG. 20, the oil separating member 800 according to the illustrated embodiment includes the compression guide part 810, the exhaust guide part 820, the mesh portion 830, the separation protruding portion 840, and the flange portion 850.

In this embodiment, the oil separation process according to the cases (1) to (4) described above is carried out.

That is, as described above, the compression guide part 810 and the exhaust guide part 820 increase the collision frequency of the mixed fluid and the refrigerant. Also, the compression guide part 810 and the exhaust guide part 820 form the exhaust passage for the refrigerant from which the oil has been separated.

The exhaust passage formed by the compression guide part 810 and the exhaust guide part 820 is not formed in a linear shape but extends in a zigzag shape so that the refrigerant comes and goes in the discharge chamber S3 in the front-rear direction of the discharge chamber S3.

Therefore, the flow distance of the refrigerant is increased, and the oil separation effect by the own weight of the oil can be improved.

The discharge mesh member 831 and the exhaust mesh member 832 of the mesh portion 830 are provided on the discharge port 628 and the exhaust end portion 823, respectively. Each of the mesh members 831 and 832 filters and separates the oil contained in the mixed fluid and the refrigerant using the particle sizes.

The separation protruding portion 840 protrudes from the inner wall of the front side of the discharging chamber S3. The mixed fluid discharged from the discharge port 628 collides with the separation protruding portion 840, so that the oil can be separated.

The compression flange 851 and the exhaust flange 852 of the flange portion 850 are provided on the compression outer circumferential surface 811 and the exhaust outer circumferential surface 821, respectively. The compression flange 851 and the exhaust flange 852 increase the frequency of collision of the mixed fluid and the refrigerant and diversify the shape of the exhaust passage of the refrigerant. Accordingly, the oil contained in the mixed fluid and the refrigerant can be separated by the collision and its own weight.

In this embodiment, various components are provided in the oil separating member 800, so that the oil can be separated from the mixed fluid and the refrigerant by the collision, the own weight of the oil, and the filtering process according to the particle sizes. Therefore, the oil separation efficiency of the mixed fluid and the refrigerant can be maximized.

The electric compressor 10 according to the present disclosure separates oil from a mixed fluid in a collision manner, not a centrifugal separation manner.

Therefore, the size and structure of the electric compressor 10 can be kept compact since no cylinder or the like is required for implementing the centrifugal separation.

An exhaust passage of a refrigerant flowing from the discharge chamber S3 to the exhaust port 220 is diversified by the compression guide part 810 and the exhaust guide part 820. The exhaust passage of the refrigerant is formed in a maze shape which is formed in a zigzag manner by the compression guide part 810 and the exhaust guide part 820.

Thus, as a path that the refrigerant flows to be exhausted is increased, a sufficient time for separating oil can be secured. In addition, the oil separation effect by the own weight of the oil can be improved.

The compression guide part 810 and the exhaust guide part 820 are located to be spaced apart from the discharge port 628. The exhaust hollow portion 822 of the exhaust guide part 820 communicates with the exhaust port 220.

Therefore, even if the compression guide part 810 and the exhaust guide part 820 are provided, they do not affect the discharge port 628 and the exhaust port 220, and thus an excessive structural change of the discharge chamber S3 is not required.

The exhaust guide part 820 is inserted into the compression hollow portion 812 of the compression guide part 810 so as to form the exhaust passage for the refrigerant. At this time, any separate member is not required to insert the exhaust guide part 820. Even when maintenance is required, it is merely allowed by separating the exhaust guide part 820 from the compression hollow portion 812.

This may facilitate manufacture and maintenance of the compression guide part 810 and the exhaust guide part 820 for forming the exhaust passage.

The discharge mesh member 831 and the exhaust mesh member 832 of the mesh portion 830 are provided on the discharge port 628 and the exhaust end portion 823, respectively. Oil contained in the mixed fluid and the refrigerant is separated by each mesh member 831, 832, according to the particle sizes.

Therefore, the oil can be separated by filtration using the particle sizes as well as collision. Thus, the oil separation efficiency can be improved.

The separation protruding portion 840 protrudes from an inner surface of the rear housing 200. The separation protruding portion 840 is configured such that the mixed fluid discharged from the discharge port 628 is collided therewith.

Therefore, an initial collision time point of the mixed fluid introduced into the discharge chamber S3 can be earlier, and also additional collision with the inner wall of the discharge chamber S3 can be expected. Accordingly, the oil separation efficiency by the collision can be improved.

In one embodiment, the protrusion end surface 842 of the separation protruding portion 840 is formed to be inclined downward. The oil separated from the mixed fluid due to the collision with the protrusion end surface 842 can be easily moved downward along the protrusion end surface 842.

Therefore, the oil separation efficiency can be improved, and the separated oil can be moved downward to be easily exhausted to the outside of the discharge chamber S3.

The compression flange 851 and the exhaust flange 852 of the flange portion 850 are provided on the compression outer circumferential surface 811 and the exhaust outer circumferential surface 821, respectively. Each flange 851 and 852 is configured to increase the frequency of collision of the mixed fluid and the refrigerant. Also, the shape of the exhaust passage of the refrigerant can be diversified by the flanges 851 and 852.

Accordingly, the oil can be separated by the increase in the frequency of collision and the oil separation by the own weight of the oil can be improved more during the flow along such complicated exhaust passage. Thus, the oil separation efficiency can be improved.

The foregoing description has been given of the preferred embodiments, but it will be apparent to those skilled in the art that various modifications and variations can be made in the present disclosure without departing from the spirit or scope of the invention as defined in the appended claims.

What is claimed is:

1. An electric compressor comprising:
a compression unit including a fixed scroll and an orbiting scroll configured to rotate relative to the fixed scroll, the compression unit configured to compress a refrigerant by a relative rotation of the orbiting scroll; and
a rear housing located opposite to the orbiting scroll and coupled to the fixed scroll to form a predetermined space,
wherein the fixed scroll comprises a compression guide part protruding from one side thereof facing the rear housing, and forms an exhaust passage for the compressed refrigerant, and
wherein the rear housing comprises an exhaust guide part protruding from one side thereof facing the fixed scroll, and forms the exhaust passage for the compressed refrigerant.

2. The electric compressor of claim 1, wherein the compression guide part covers at least part of an outer circumferential surface of the exhaust guide part.

3. The electric compressor of claim 2, wherein each of the compression guide part and the exhaust guide part has a cylindrical shape with a hollow portion formed therein, and
wherein the exhaust guide part is at least partially inserted into the hollow portion of the compression guide part.

4. The electric compressor of claim 2, wherein each of the compression guide part and the exhaust guide part has a polygonal shape with a hollow portion formed therein, and
wherein the exhaust guide part is at least partially inserted into the hollow portion of the compression guide part.

5. The electric compressor of claim 2, wherein each of the compression guide part and the discharge guide portion includes are a hollow portion therein, and has a shape of a column with at least one curved side surface, and
wherein the exhaust guide part is at least partially inserted into the hollow portion of the compression guide part.

6. The electric compressor of claim 3, wherein the exhaust guide part is inserted into the hollow portion of the compression guide part so that an outer circumferential surface of the exhaust guide part is spaced apart by a predetermined distance from an inner circumferential surface of the compression guide part.

7. The electric compressor of claim 6, wherein the exhaust passage of the refrigerant includes the predetermined space, and a space formed between the outer circumferential surface of the exhaust guide part and the inner circumferential surface of the compression guide part spaced apart from each other.

8. The electric compressor of claim 1, wherein the fixed scroll and the orbiting scroll are spaced apart from each other by a predetermined distance so that a space for compressing the refrigerant is formed between the fixed scroll and the orbiting scroll,
wherein the fixed scroll includes a discharge port through which the space for compressing the refrigerant and the compression guide part communicate with each other, and
wherein the discharge port is located lower than the compression guide part and the exhaust guide part in a downward direction.

9. The electric compressor of claim 3, wherein the rear housing includes an exhaust port through which the predetermined space and an outside of the rear housing communicate with each other, and
wherein the exhaust guide part is disposed such that the hollow portion of the exhaust guide part communicates with the exhaust port.

10. The electric compressor of claim 1, wherein the exhaust guide part includes an exhaust mesh member disposed on one end portion thereof facing the fixed scroll, and a plurality of filtering holes for separating oil mixed with the compressed refrigerant.

11. The electric compressor of claim 1, wherein the rear housing includes a separation protruding portion protruding from one side thereof facing the fixed scroll, so that oil mixed with the compressed refrigerant is separated as the compressed refrigerant collides with the separation protruding portion.

12. The electric compressor of claim 11, wherein the separation protruding portion has one side surface, facing the fixed scroll, formed to be inclined downward in a downward direction.

13. The electric compressor of claim 11, wherein the fixed scroll and the orbiting scroll are spaced apart from each other by a predetermined distance so that a space for compressing the refrigerant is formed between the fixed scroll and the orbiting scroll,
wherein the fixed scroll is provided with a discharge port formed therethrough such that the space for compressing the refrigerant and the compression guide part communicate with each other, and
wherein the separation protruding portion is located on a virtual line extending from the discharge port.

14. The electric compressor of claim 11, wherein the fixed scroll and the orbiting scroll are spaced apart from each other by a predetermined distance so that a space for compressing the refrigerant is formed between the fixed scroll and the orbiting scroll,
wherein the fixed scroll is provided with a discharge port formed therethrough such that the space for compressing the refrigerant and the compression guide part communicate with each other, and
wherein the discharge port includes a discharge mesh member disposed on one side thereof facing the fixed scroll, and a plurality of filtering holes for separating the oil mixed with the compressed refrigerant.

15. The electric compressor of claim 1, wherein the compression guide part includes a compression flange protruding from an outer circumferential surface thereof, and
wherein the exhaust guide part includes an exhaust flange protruding from an outer circumferential surface thereof.

16. The electric compressor of claim 10, wherein the rear housing includes an oil exhaust passage formed in a lower side thereof and through which the oil separated from the compressed refrigerant is exhausted.
